(19) United States
(12) Patent Application Publication
(10) Pub. No.: US 2009/0040435 A1
(43) Pub. Date: Feb. 12, 2009

(54) LIQUID CRYSTAL DISPLAY DEVICE

(75) Inventor: Yuta Takahashi, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/816,654

(22) PCT Filed: Feb. 23, 2006
(86) PCT No.: PCT/JP2006/303924

§ 371 Date: Aug. 20, 2007

(30) Foreign Application Priority Data
Feb. 23, 2005 (JP) 2005-048017

(51) Int. Cl. G02F 1/1335

(52) U.S. Cl. 349/96

(57) ABSTRACT

A liquid crystal display device comprising a light source, a polarizing film and a liquid crystal cell in this order, wherein a first optical compensation film having an in-plane retardation (Re) of 0 to 20 nm and a retardation (Rth) in the thickness direction of −1000 to 20 nm is provided between the light source and the polarizing film. The liquid crystal display device shows an improved utility efficiency of light.

### TECHNICAL FIELD

The present invention relates to a liquid crystal display device, and more particularly, to a liquid crystal display device showing an improved utility efficiency of light.

### BACKGROUND ART

Liquid crystal display devices have been used in various fields such as personal computers. Recently, demands for liquid crystal display devices have increased rapidly. In the recent liquid crystal display devices, there has been a demand in that a back-light is to be thin, a high precision image is to be displayed, and a high brightness image is to be displayed. Using a thin back-light and displaying a high precision image are likely to result in low brightness of the image.

To establish a thin back-light, a high precision image, and a high brightness image, it is desirable that the utility efficiency of light is improved so as to compensate brightness. As a specific unit for improving brightness, a brightness enhancing film (reflection polarizing plate) has been suggested. The brightness enhancing film is largely classified into a linearly polarized light-separating type (e.g., see JP-A Nos. 4-268505, 9-507308 and 10-511322) and a circularly polarized light-separating type (e.g., see JP-A Nos. 8-271837, 8-271731, 10-321025, 11-174230 and 11-248942). Any one of the brightness enhancing films is provided between a lower polarizing plate (light-absorbing polarizing element) and a light source (back-light). By utilizing the brightness enhancing film, the utility efficiency of light in a liquid crystal display device is remarkably improved, which make it possible to considerably decrease electric power consumption.

### DISCLOSURE OF THE INVENTION

The present inventors have investigated a liquid crystal display device equipped with a brightness enhancing film, and found that that when the liquid crystal display device is inclined to one side, the image thereof is sometimes colored into blue or yellow. Also, the problems that the effects of enhancing brightness are not sufficient and also that the brightness suddenly decreases depending on the situations, have been found. The problems can be solved by adjusting optical parameters of a liquid crystal cell and other parts of a liquid crystal display device. However, when the optical parameters of parts of a liquid crystal display device are changed, other optical problems often occurs.

In addition, a circularly polarized light-separating type brightness enhancing film includes λ/4 plate. Most of λ/4 plates used nowadays are retardation plates which exhibit optical anisotropy by stretching a polymer film. The optical direction of the polymer film is usually the direction corresponding to the vertical direction or horizontal direction of the sheet-shaped or roll-shaped film, thus it is difficult to produce a polymer film having an optic axis or a slow axis to the inclined direction of the sheet or roll. In most cases of using a retardation plate, it is provided at an angle of which is neither parallel nor perpendicular to the absorption axis of the polarizing plate. Further, there are many cases of using two or more sheets of a retardation plate and a polarizing plate at an angle neither of which is parallel nor perpendicular to the absorption axis of the polarizing plate, respectively. In general, the absorption axis of the polarizing plate is in the perpendicular direction to the roll-shaped film, thus in order to fit by adhering the retardation plate and the polarizing plate, it is necessary to fit by adhering the tips obtained by cutting each film at a predetermined angle. When producing a laminate of the retardation plate and the polarizing plate by interposing the tip in between, a process for coating an adhesive, or a process for cutting the tip or interposing the tip in between is need. Therefore, the treatment becomes complex, quality lowering is easily occurred by crossing of the axes, the productivity is reduced, the cost is increased, and deterioration due to contamination is easily occurred.

The invention is made in view of the above-mentioned problems, and thus an object of the invention is to assuredly improve the utility efficiency of light in a liquid crystal display device without causing any problems of the coloration of the image. Further, another object of the invention is to provide a liquid crystal display device including a brightness enhancing film with remarkably high productivity.

The objects of the invention are achieved by the liquid crystal display devices as described in (1) to (7) below.

(1) A liquid crystal display device comprising a light source, a polarizing film and a liquid crystal cell in this order, wherein a first optical compensation film (referred to as the ‘optical compensation film (1) hereinafter) having an in-plane retardation (Re) of 0 to 20 nm and a retardation (Rth) in the thickness direction of −1000 to 20 nm is provided between the light source and the polarizing film.

(2) The liquid crystal display device as described in (1), wherein the optical compensation film (1) contains an optically anisotropic layer containing at least one kind of liquid crystalline compound.

(3) The liquid crystal display device as described in (2), wherein the optically anisotropic layer included in the optical compensation film (1) contains a rod-shaped liquid crystalline compound, and the alignment state is fixed such that the longitudinal direction of the rod-shaped liquid crystalline compound is substantially perpendicular to the film plane of the optical compensation film (1).

(4) The liquid crystal display device as described in (2) or (3), wherein the optical compensation film (1) comprises at least a support and the optically anisotropic layer provided on the support, and the support has an in-plane retardation (Re) of 0 to 20 nm and a retardation (Rth) in the thickness direction of −10 to 100 nm.

(5) The liquid crystal display device as described in any one of (1) to (4), wherein the optical compensation film (1) is a protective film of the polarizing film.

(6) The liquid crystal display device as described in any one of (1) to (5), wherein the optical compensation film (1) and another optical compensation film (referred to as the ‘optical compensation film (2) hereinafter) are provided between the light source and the polarizing film, and the optical compensation film (2) has an in-plane retardation (Re) of 50 to 200 nm.

(7) The liquid crystal display device as described in (6), wherein a cholesteric liquid crystal layer is further provided between the light source and the polarizing film so as to be closer to the light source than both the optical compensation film (1) and the optical compensation film (2).

According to the invention, a liquid crystal display device, which has improved on the utility efficiency of light in a liquid crystal display device without causing any problems of the coloration of the image, can be provided. Further, a liquid crystal display device including a brightness enhancing film with remarkably high productivity can be provided.

### DESCRIPTION OF THE PREFERRED EMBODIMENT

Hereinafter, the embodiments of the present invention will be described in the orderly manner. In addition, the numerical range expressed using the word ‘to’ herein means the range including the values denoted after and before the word ‘to’ as a lower limit value and an upper limit value.

The terms ‘parallel’ and ‘perpendicular’ in the specification is defined as the range within the accurate angle less than ±10° of the accurate angle. In this range, an error with the accurate angle is preferably less than ±5°, and more preferably less than ±2°. Further, the term ‘substantially vertical’ is defined as a position within the range less than ±20° rather than the accurate vertical angle. This range of error with the accurate angle is preferably less than ±15°, and more preferably less than ±10°. Moreover, the term ‘slow axis’ is defined as a direction within the plane of film where the refractive index is the highest. In addition, the wavelength for the measurement of the refractive index in a visible broadband having a wavelength (λ) of 550 nm unless specifically described.

In the specification, the term ‘polarizing plate’, unless specifically described, means a long polarizing plate as well as a polarizing plate cut to a size built into the LCD (the term ‘cut’ includes meaning such as ‘punch’, ‘clip’, etc.). In addition, the terms ‘polarizing film’ and ‘polarizing plate’ are discriminated from each other. However, the term ‘polarizing plate’ means a stacked structure having a transparent protective layer on at least one surface of the term ‘polarizing film’ for protecting the corresponding polarizing film.

Further in the specification, the term a light-scattering or light-reflecting polarizing element is defined as a polarizer having a function that penetrates a linearly polarized component which is parallel to the polarization axis and then scatters or reflects a linearly polarized component which is perpendicular to the axis. The term a light-absorbing polarizing element is defined as a polarizer having a function that penetrates a linearly polarized component that is parallel to the polarization axis and absorbs a linearly polarized component that is perpendicular to the axis.

Further, when it is only referred to as ‘polarized light’, as used herein, it does not mean polarized light in a broad meaning (containing linearly polarized light, circularly polarized light and elliptically polarized light), but polarized light in a narrow meaning (only linearly polarized light).

As used in the present specification, Re and Rth are an in-plane retardation and a retardation in the thickness direction at the wavelength λ nm, respectively. Re is measured by entering light having a wavelength of λ nm in the normal direction of the film in the KOBRA21ADH, trade name (manufactured by Oji Scientific Instruments Co. Ltd.). Rth is calculated by using the KOBRA21ADH, on the basis of retardation values measured in three directions, that is, the Re, a retardation value measured by entering the light of wavelength λ nm in the direction inclined to +40° over the normal direction of the film, with the in-plane retarded axis (judged by the KOBRA21ADH) as an inclined axis (an axis of rotation), and a retardation value measured by entering the light of wavelength λ nm in the direction inclined to −40° over the normal direction of the film, with the in-plane retarded axis as an inclined axis (an axis of rotation). Herein, an assumed value of an average refractive index may use a value in various optical film catalogs and Polymer Handbook (JOHN WILEY & SONS, INC.). As to an average refractive index value other than an existent one, it can be measured using ABBE Refractometer. The value of average refractive index for the main polymer films are as follows: Cellulose acylate (1.48), Cycloolefin polymer (1.52), Polycarbonate (1.59), Polymethyl methacrylate (1.49), and Polystyrene (1.59).

[Optical Compensation Film]

The liquid crystal display device of the invention contains at least an optical compensation film having an in-plane retardation (Re) of 0 to 20 nm and a retardation (Rth) in the thickness direction of −1000 to 20 nm (sometimes referred to as the ‘optical compensation film (1)’). Re is more preferably 0 to 10 nm. Rth is more preferably −800 to 10 nm, and even more preferably −600 to 0 nm. The liquid crystal display device of the invention comprises a light source, a polarizing film and a liquid crystal cell, and the light source, the polarizing film and the liquid crystal cell are provided in this order. Further, the optical compensation film (1) is provided between the light source and the polarizing film.

The retardation value measured from the normal direction in the film plane of the optical compensation film (1) is referred as Re (0). By having the slow axis of the optical compensation film (1) as an inclined axis, the retardation value measured by inclination of optical compensation film (1) by 40° is Re (40), and the retardation value measured by inclination by 40° to the opposite side with the inclined direction is Re (−40). At this time, the refractive index in the thickness direction (Rth) can be measured from the three measured values of Re (0), Re (40) and Re (−40), thickness of the retardation plate and the average refractive index. Further, when the slow axis of the optical compensation film (1) is not detectable, an arbitrary direction in the plane may be referred as an inclined axis.

The optical compensation film (1) may be formed from a birefringence polymer film and may be formed from an optically anisotropic layer containing a liquid crystalline compound. The optically anisotropic layer containing a liquid crystalline compound includes an optically anisotropic layer formed by fixating the molecules of the liquid crystalline compound to the alignment state. When the optical properties are satisfied, the optical compensation film may be formed from a single layer, or may be formed from a laminate of two layers or more.

In addition to the optical compensation film (1), the liquid crystal display device of the invention may further contain an optical compensation film (2). For the optical compensation film (2), Re is preferably 50 to 200 nm, more preferably 70 to 180 nm, and even more preferably 90 to 160 nm. Further, the Re (40) and Re (−40) being substantially the same is preferred. The difference between the Re (40) and Re (−40) is most preferably 0 nm, but considering the error or the like, the difference in the range of 4 nm is said to be substantially the same herein.

The optical compensation film (2) preferably has a broadband property such that as the wavelength is enlarged, Re is also enlarged. For example, in order to exhibit the broadband property, a technique for laminating a layer having a Re of ½ wavelength substantially and a layer having a Re of ¼ wavelength substantially by crossing the respective slow axes is described in JP-A No. 2000-284126. Further, a technique for exhibiting the broadband property by stretching a modified polycarbonate film is described in WO 00/26705. According to these techniques, a broadband retardation plate which exhibit a desired Re can be suitably used as a second optically anisotropic layer.

[Optical Compensation Film Containing Liquid Crystalline Compound]

The kind of a liquid crystalline compound is not particularly limited as long as it satisfies the above-mentioned optical properties. For example, an optically anisotropic layer, which can be obtained by forming a low molecular liquid crystalline compound in the nematic alignment in liquid crystal state, and forming an optically anisotropic layer which can be obtained by subjecting to fixation by optically crosslinking or thermally crosslinking, or forming a high molecular liquid crystalline compound in the nematic alignment in liquid crystal state, and then cooling to fixate the alignment, can be used. Further in the invention, even if a liquid crystalline compound may be used in an optically anisotropic layer, the optically anisotropic layer is a layer fixed and formed by the polymerization or the like of the liquid crystalline compound, thus does not need to show crystallinity once the layer is formed. The polymerizable liquid crystalline compound may be a multifunctional polymerizable liquid crystalline compound, and may also be a monofunctional polymerizable liquid crystalline compound. In addition, the liquid crystalline compound may be a discotic liquid crystalline compound, and may also be a rod-shaped liquid crystalline compound.

A liquid crystalline compound used in an optically anisotropic layer containing the optical compensation film (1), may be a discotic liquid crystalline compound, and may also be a rod-shaped liquid crystalline compound. If a liquid crystalline compound satisfies the above-mentioned optical properties, its alignment state may be any one of the vertical alignment, the horizontal alignment, the hybrid alignment or the inclined alignment. In controlling Rth of an optical compensation film (1), a rod-shaped liquid crystalline compound can be preferably used, and it is more preferable when the longitudinal direction of a rod-shaped liquid crystalline compound is substantially vertical to the film plane of the optical compensation film (1). A rod-shaped liquid crystalline compound being substantially vertical is defined as an angle between the plane of the optical compensation film (1) and the director of the rod-shaped liquid crystalline compound to be within the range of 70° to 90°. The angle may be in the inclined alignment such that the average inclination angle is in this range, and may be in the hybrid alignment in which the inclination angle varies. In both cases of inclined alignment and hybrid alignment, the average inclination angle of the rod-shaped liquid crystalline compound is preferably 70° to 90°, more preferably 80° to 90°, and even more preferably 85° to 90°.

A liquid crystalline compound used in an optically anisotropic layer containing the optical compensation film (2), may be a discotic liquid crystalline compound, and may also be a rod-shaped liquid crystalline compound. If a liquid crystalline compound satisfies the above-mentioned optical properties, its alignment state may be any one of the vertical alignment, the horizontal alignment, the hybrid alignment or the inclined alignment. In order to prepare a retardation plate with symmetrical viewing angle-dependency, the disc plane of discotic liquid crystalline compound is substantially vertical to the film plane of the optical compensation film (2), or preferably the longitudinal direction of rod-shaped liquid crystalline compound is substantially horizontal to the film plane of the optical compensation film (2). A discotic liquid crystalline compound being substantially vertical is defined as an angle between the plane of the optical compensation film (2) and the disc plane of the discotic liquid crystalline compound to be within the range of 70° to 90°. The angle may be in the inclined alignment such that the average inclination angle of the disc plane is in this range, and may be in the hybrid alignment in which the inclination angle varies. In both cases of inclined alignment and hybrid alignment, the average inclination angle of the rod-shaped liquid crystalline compound is preferably 70° to 90°, more preferably 80° to 90°, and even more preferably 85° to 90°. A rod-shaped liquid crystalline compound being substantially horizontal is defined as an angle between the plane of the optical compensation film (2) and the director of the rod-shaped liquid crystalline compound to be within the range of 0° to 20°. The angle may be in the inclined alignment such that the average inclination angle of the rod-shaped liquid crystalline compound is in this range, and may be in the hybrid alignment in which the inclination angle varies. In both cases of inclined alignment and hybrid alignment, the average inclination angle of the rod-shaped liquid crystalline compound is preferably 0° to 20°, more preferably 0° to 10°, and even more preferably 0° to 5°.

The optically anisotropic layer can be formed by coating a rod-shaped liquid crystalline compound or a discotic liquid crystalline compound, and if necessary, a composition containing the following polymerization initiator, air interface alignment material and other additives (hereinafter, sometimes referred to as the ‘liquid crystalline composition’) onto a support. It is preferable to form an alignment layer on a support, and then to coat the liquid crystalline composition onto the surface of the alignment layer.

[Discotic Liquid Crystalline Compound]

In the invention, it is preferable to form an optically anisotropic layer using a discotic liquid crystalline compound. The discotic liquid crystalline compound is disclosed in various publications (C. Destrade, et al., Mol. Crysr. Liq. Cryst., Vol. 71, p. 111 (1981); Chemical Society of Japan, Quarterly Journal of General Chemistry, No. 22, Chemistry of Liquid Crystal, Chap. 5, Chap. 10, Sec. 2 (1994); B. Kohne, et al. Angew. Chem. Soc. Chem. Comm., p. 1794 (1985); J. Zhang, et al., J. Am. Chem. Soc., Vol. 116, p. 2655 (1994)). Polymerization of a discotic liquid crystalline compound is described in JP-A No. 8-27284.

A discotic liquid crystalline compound preferably contains a polymerizable group for allowing fixation by polymerization. For example, a structure having a polymerizable group as a substituent bonded onto the discotic core of the discotic liquid crystalline compound can be considered, but when a polymerizable group is directly bonded to the discotic core, it is difficult to maintain the alignment state during the polymerization reaction. Therefore, a structure having a linking group between the discotic core and the polymerizable group is preferred. That is, a discotic liquid crystalline compound having a polymerizable group is preferably a compound represented by the following formula.

D(−L−P)ₙ

wherein D is a discotic core, L is a divalent linking group, P is a polymerizable group and n is an integer of 4 to 12. Preferable specific examples of the discotic core (D), a divalent group (L) and a polymerizable group (P) in the formula are disclosed in (D1) to (D15), (L1) to (L25) and (P1) to (P18) of JP-A No. 2001-4837, respectively, and the disclosed contents in the publication can be preferably used. Further, the transition temperature of discotic nematic liquid crystal phase-solid phase of the liquid crystalline compound is preferably 70 to 300° C., and more preferably 70 to 170° C.

[Rod-Shaped Liquid Crystalline Compound]

In the invention, it is preferable to form an optically anisotropic layer using a rod-shaped liquid crystalline compound. For the rod-shaped liquid crystalline compound, azomethines, azoxys, cyano biphenyls, cyano phenyl esters, benzoic acid esters, cyclohexanecarboxylic acid phenyl esters, cyano phenylcyclohexanes, cyano-substituted phenylpyrimidines, alkoxy-substituted phenylpyrimidines, phenyldioxanes, tolanes and alkenyl cyclohexylbenzonitriles, are preferably used. Not only these low-molecular weight liquid crystalline compounds, but also high-molecular weight liquid crystalline compounds can be used. It is more preferable to fix the alignment by polymerization of a rod-shaped liquid crystalline compound. A liquid crystalline compound having a partial structure which may conduct polymerization or crosslinking reaction with active light or electron ray, heat or the like can be preferably used. The number of such partial structures is preferably 1 to 6, and more preferably 1 to 3. For the polymerizable rod-shaped liquid crystalline compound, a compound disclosed in Makromol. Chem., Vol. 190, p. 2255 (1989), Advanced Materials, Vol. 5, p. 107 (1993), U.S. Pat. Nos. 4,683,327, 5,622,648 and 5770107, WO95/22586, WO95/24455, WO97/00600, WO98/23580, WO98/52905, JP-A Nos. 1-272551, 6-16616, 7-110469, 11-80081 and 2001-328973, can be used.

[Vertical Alignment Promoting Agent]

In order to uniformly align a liquid crystalline compound vertically, it is necessary to control alignment vertically of the liquid crystalline compound in an alignment layer interface side and an air interface side. In this regard, a composition which added a compound that gives the vertically aligning action to the liquid crystalline compound by means of an exclusion volume effect, an electrostatic effect or a surface energy effect at the time of aligning the liquid crystalline compound, may be employed. Also, with respect to regulating the alignment of an air interface side, a composition which added a compound that gives vertically aligning action to the liquid crystalline compound by means of an exclusion volume effect, an electrostatic effect or a surface energy effect at the time of aligning the liquid crystalline compound, may be employed. For the compound (alignment layer interface side vertical alignment material) that promotes vertically aligning of the molecules of the liquid crystalline compound at the interface side of these alignment layers, a pyridinium derivative can be preferably used. As for a compound (air interface side vertical alignment material) that promotes vertically aligning of the molecules of the liquid crystalline compound at the interface side of these alignment layers, a compound, which promotes maldistribution of the above-mentioned compounds, containing at least one or more hydrophilic group selected from a fluoro aliphatic group, a carboxyl group (—COOH), a sulfo group (—SO₃H), a phosphonoxy group {—OP(═O)(OH)₂} and their salts can be more preferably used. Further, by combining these compounds, for example, when the crystalline compound is prepared as a coating solution, the coatability of the coating solution is improved, and thus generation of unevenness and fish eye are inhibited. Hereinbelow, the vertical alignment material will be described in detail.

[Alignment Layer Interface Side Vertical Alignment Material]

For the alignment layer interface side vertical aligning material used in the invention, a pyridinium derivative (pyridinium salt) represented by the following Formula (I) can be suitably used. By adding at least one kind of the pyridinium derivative to the liquid crystalline composition, it is possible to align the molecules of a discotic liquid crystalline compound in the substantially vertical direction near an alignment layer.

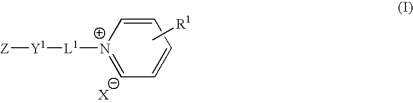

In Formula (I), L¹ is a divalent liking group, and preferably a divalent liking group having 1 to 20 carbon atoms comprising a combination of an alkylene with —O—, —S—, CO—, —SO₂—, NR^{a}— (provided that, R^{a} is an alkyl group having 1 to 5 carbon atoms or a hydrogen atom), an alkenylene group, alkynylene group or an arylene group. The alkylene group may be a linear chain or a branched chain.

In Formula (I), R¹ is a hydrogen atom, an unsubstituted amino group or a substituted amino group substituted with a substituent having 1 to 20 carbon atoms. When R¹ is a substituted amino group, it is preferable to be substituted with an aliphatic group. Examples of the aliphatic group include an alkyl group, a substituted alkyl group, an alkenyl group, a substituted alkenyl group, an alkynyl group and a substituted alkynyl group. In addition, when R¹ is a 2-substituted amino group, two aliphatic groups may be bonded to each other to form a nitrogen-containing aromatic heterocyclic ring. At this time, the formed nitrogen-containing aromatic heterocyclic ring is preferably a 5- or 6-membered ring. R¹ is preferably a hydrogen atom, an unsubstituted amino group or a substituted amino group having 1 to 20 carbon atoms, more preferably a hydrogen atom, an unsubstituted amino group or a substituted amino group having 2 to 12 carbon atoms, and even more preferably a hydrogen atom, an unsubstituted amino group or a substituted amino group having 2 to 8 carbon atoms. When R¹ is an amino group, it is preferable that a pyridinium ring is substituted at the 4-position.

In Formula (I), X is an anion. Examples of the anion include a halogen anion (e.g., a fluorine ion, a chlorine ion, bromine ion, an iodine ion, etc.), a sulfonate ion (e.g., a methane sulfonate ion, a trifluoromethane sulfonate ion, a methylsulfate ion, a p-toluene sulfonate ion, a p-chlorobenzene sulfonate ion, a 1,3-benzene disulfonate ion, a 1,5-naphthalene disulfonate ion and a 2,6-naphthalene disulfonate ion), a sulfate ion, a carbonate ion, a nitrate ion, a thiocyanate ion, a perchlorate ion, a tetrafluoroborate ion, a picrate ion, an acetate ion, a formate ion, a trifluoroacetate ion, a phosphate ion (e.g., hexafluorophosphate ion), a hydroxyl ion, and the like. X is preferably a halogen anion, a sulfonate ion, or a hydroxyl ion.

In Formula (I), Y¹ is a divalent linking group having 1 to 30 carbon atoms including a 5- or 6-membered ring as a partial structure. The annular partial structure contained in Y¹ is preferably a cyclohexyl ring, an aromatic ring or a heterocyclic ring. Examples of the aromatic ring include a benzene ring, an indene ring, a naphthalene ring, a fluorene ring, a phenanthrene ring, an anthracene ring, a biphenyl ring and a pyrene ring. A benzene ring, a biphenyl ring and a naphthalene ring are particularly preferred. For the hetero atom composing a heterocyclic ring, a nitrogen atom, an oxygen atom and a sulfur atom are preferred, and examples of the heterocyclic ring include a furan ring, a thiophene ring, a pyrrole ring, a pyrroline ring, a pyrrolidine ring, an oxazole ring, an isooxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a dioxane ring, a dithiane ring, a thiine ring, a pyridine ring, a piperidine ring, an oxazine ring, a morpholine ring, a thiazine ring, a pyridazine ring, a pyrimidine ring, a pyrazine ring, a piperazine ring and a triazine ring. Heterocyclic ring is preferably a 6-membered ring. The divalent linking group having a 5- or 6-membered ring as a partial structure represented by Y may have a substituent.

In Formula (I), Z is a halogen-substituted phenyl group, a nitro-substituted phenyl group, a cyano-substituted phenyl group, a phenyl group substituted with an alkyl group having 1 to 10 carbon atoms, a phenyl group substituted with an alkoxy group having 2 to 10 carbon atoms, an alkyl group having 1 to 12 carbon atoms, an alkynyl group having 2 to 20 carbon atoms, an alkoxy group having 1 to 12 carbon atoms, an alkoxycarbonyl group having 2 to 13 carbon atoms, an aryloxycarbonyl group having 7 to 26 carbon atoms or an arylcarbonyl group having 7 to 26 carbon atoms, with a cyano-substituted phenyl group, a halogen-substituted phenyl group, a phenyl group substituted with an alkyl group having 1 to 10 carbon atoms, a phenyl group substituted with an alkoxy group having 2 to 10 carbon atoms, an aryloxycarbonyl group having 7 to 26 carbon atoms, an arylcarbonyl group having 7 to 26 carbon atoms being preferred.

Z may further have substituents, and examples thereof include a halogen group (a fluorine atom, a chlorine atom, a bromine atom and an iodine atom), a cyano group, a nitro group, an alkyl group having 1 to 16 carbon atoms, an alkenyl group having 1 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, an alkyl-substituted carbamoyl group having 2 to 16 carbon atoms and an acylamino group having 2 to 16 carbon atoms.

For the pyridinium compound used in the invention, a pyridinium compound represented by the following Formula (Ia) is preferred.

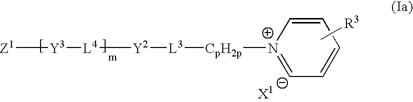

In the formula (Ia), L³ is a single bond, —C—, —C—CO—, —CO—O—, —C≡C—, —CH═CH—, —CH═N—, —N═CH—, —N═N—, —C-AL-O—, —O-AL-C—CO—, —C-AL-CO—O—, —CO—C-AL-O—, —CO—C-AL-C—CO—, —CO—O-AL-CO—O—, —O—CO-AL-O—, —O—CO-AL-O—CO— or —C—CO-AL-CO—O—. AL is an alkylene group having 1 to 10 carbon atoms. L³ is preferably a single bond, —O—, —O-AL-O—, —O-AL-C—CO—, —O-AL-CO—O—, —CO—C-AL-O—, —CO—C-AL-C—CO—, —CO—C-AL-CO—O—, —C—CO-AL-O—, —O—CO-AL-C—CO— or —O—CO-AL-CO—O—, and more preferably a single bond or —O—.

In the formula (Ia), L⁴ is a single bond, —O—, —C—CO—, —CO—O—, —C≡C—, —CH═CH—, —CH═N—, —N═CH— or —N═N—.

In Formula (Ia), R³ is a hydrogen atom, an unsubstituted amino group or an alkyl-substituted amino group having 2 to 20 carbon atoms. When R³ is an alkyl-substituted amino group, two alkyl groups may be bonded to each other to form a nitrogen-containing heterocyclic ring. At this time, the formed nitrogen-containing heterocyclic ring is preferably a 5- or 6-membered ring. R³ is more preferably a hydrogen atom, an unsubstituted amino group or an alkyl-substituted amino group having 2 to 12 carbon atoms, and most preferably a hydrogen atom, an unsubstituted amino group or an alkyl-substituted amino group having 2 to 8 carbon atoms. When R³ is an unsubstituted amino group, it is preferable that a pyridinium ring is substituted with amino at the 4-position.

In Formula (Ia), Y² and Y³ are each independently a divalent group comprising a 6-membered ring which may have a substituent. Examples of the 6-membered ring include an aliphatic ring, an aromatic ring (a benzene ring) and a heterocyclic ring. Examples of the 6-membered aliphatic ring include a cyclohexane ring, a cyclohexene ring, and a cyclohexadiene ring. Examples of the 6-membered heterocyclic ring include a pyran ring, a dioxane ring, a dithiane ring, a thiine ring, a pyridine ring, a piperidine ring, an oxazine ring, a morpholine ring, a thiazine ring, a pyridazine ring, a pyrimidine ring, a pyrazine ring, a piperazine ring and a triazine ring. The 6-membered ring may form a condensed ring with other 6- or 5-membered rings.

Examples of the substituent include a halogen atom, a cyano group, an alkyl group having 1 to 12 carbon atoms and an alkoxy group having 1 to 12 carbon atoms. The alkyl group and the alkoxy group may be substituted with an acyl group having 2 to 12 carbon atoms or an acyloxy group having 2 to 12 carbon atoms. The definition of the acyl group and the acyloxy group will be described below.

In Formula (Ia), X¹ is an anion. X¹ is preferably a monovalent anion. Examples of the anion include a halogen anion (e.g., a fluorine ion, a chlorine ion, a bromine ion and an iodine ion) and a sulfonate ion (e.g., a methane sulfonate ion, a p-toluene sulfonate ion and a benzene sulfonate ion).

In Formula (Ia), Z¹ is a hydrogen atom, a cyano group, an alkyl group having 1 to 12 carbon atoms or an alkoxy group having 1 to 12 carbon atoms, wherein the alkyl group and an alkoxy group may be substituted with an acyl group having 2 to 12 carbon atoms or an acyloxy group having 2 to 12 carbon atoms, respectively.

In Formula (Ia), m is 1 or 2, and when m is 2, two L⁴'s and two Y³ 's may be different from each other.

When m is 2, Z¹ is preferably a cyano group, an alkyl group having 1 to 10 carbon atoms or an alkoxy group having 1 to 10 carbon atoms.

When m is 1, Z¹ is preferably an alkyl group having 7 to 12 carbon atoms, an alkoxy group having 7 to 12 carbon atoms, an acyl-substituted alkyl group having 7 to 12 carbon atoms, an acyl-substituted alkoxy group having 7 to 12 carbon atoms, an acyloxy-substituted alkyl group having 7 to 12 carbon atoms, or an acyloxy-substituted alkoxy group having 7 to 12 carbon atoms.

The acyl group is represented by —CO—R and the acyloxy group is represented by —O—CO—R, wherein R is an aliphatic group (an alkyl group, a substituted alkyl group, an alkenyl group, a substituted alkenyl group, an alkynyl group and a substituted alkynyl group) or an aromatic group (an aryl group and a substituted aryl group) R is preferably an aliphatic group, and more preferably an alkyl group or an alkenyl group.

In Formula (Ia), p is an integer of 1 to 10. CₚH₂ₚ represents a chained alkylene group which may have a branched structure. CₚH₂ₚ is preferably a linear alkylene group. Further, p is more preferably 1 or 2.

Hereinbelow, specific examples of the compounds represented by Formula (I) and/or (Ia) are listed. Herein, Me represents a methyl group.

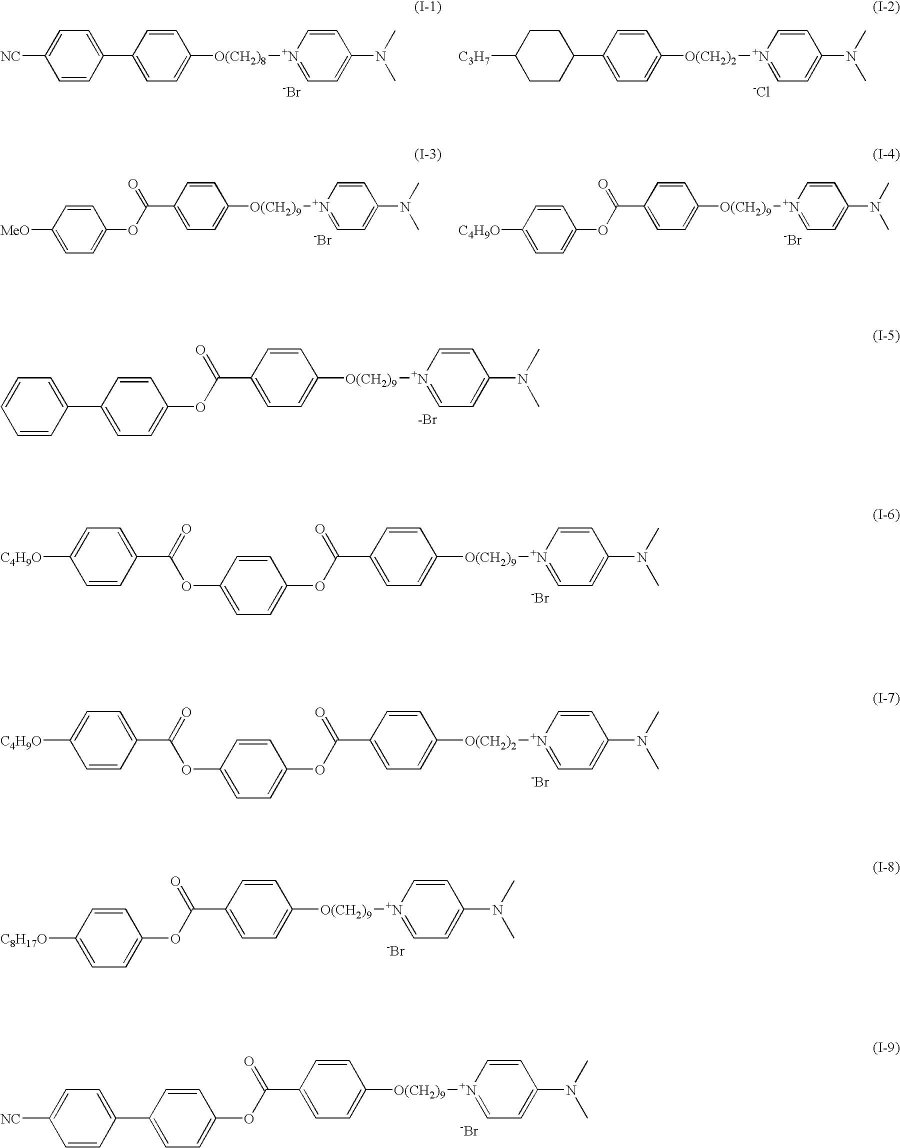

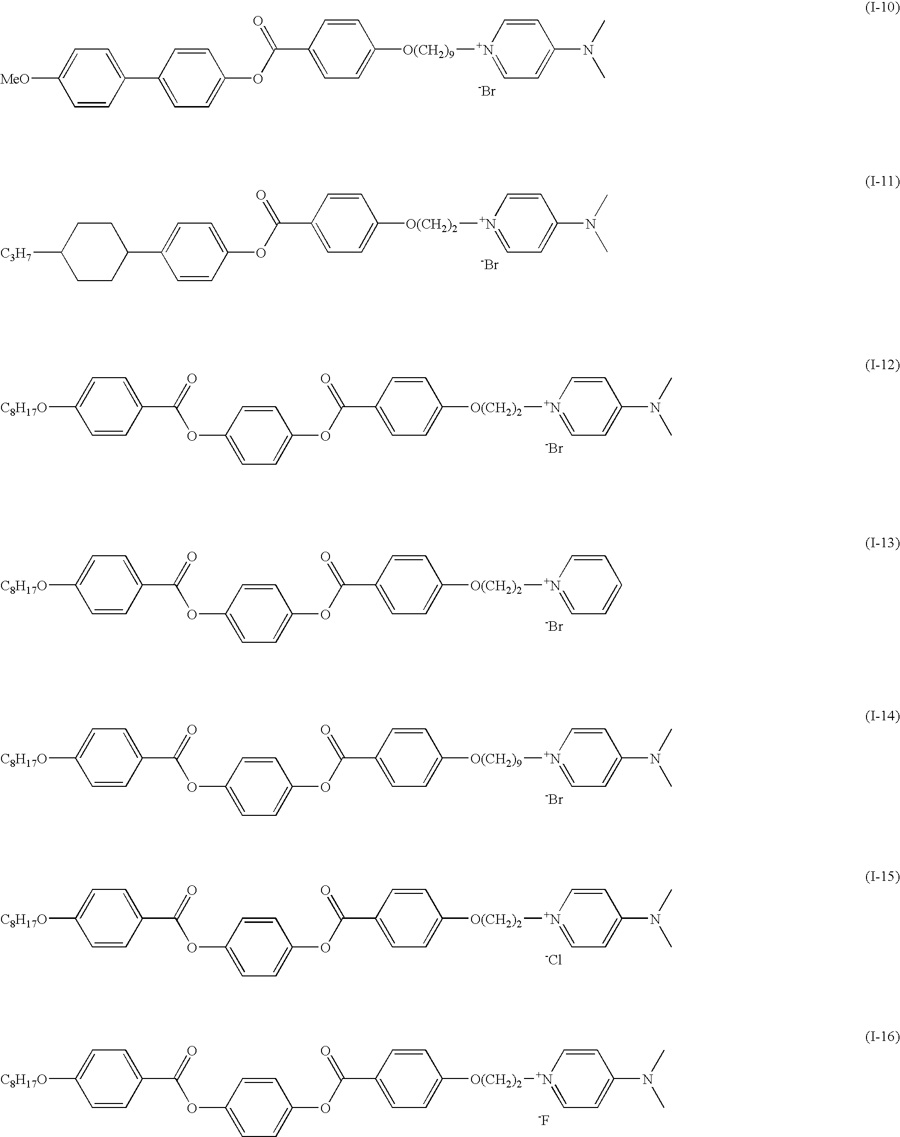

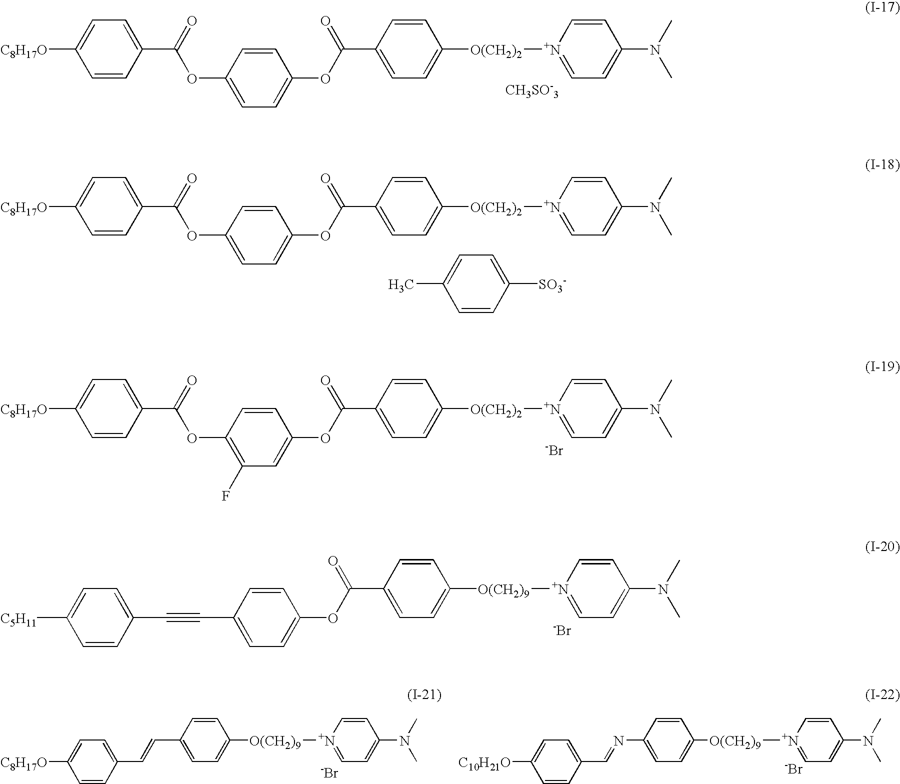

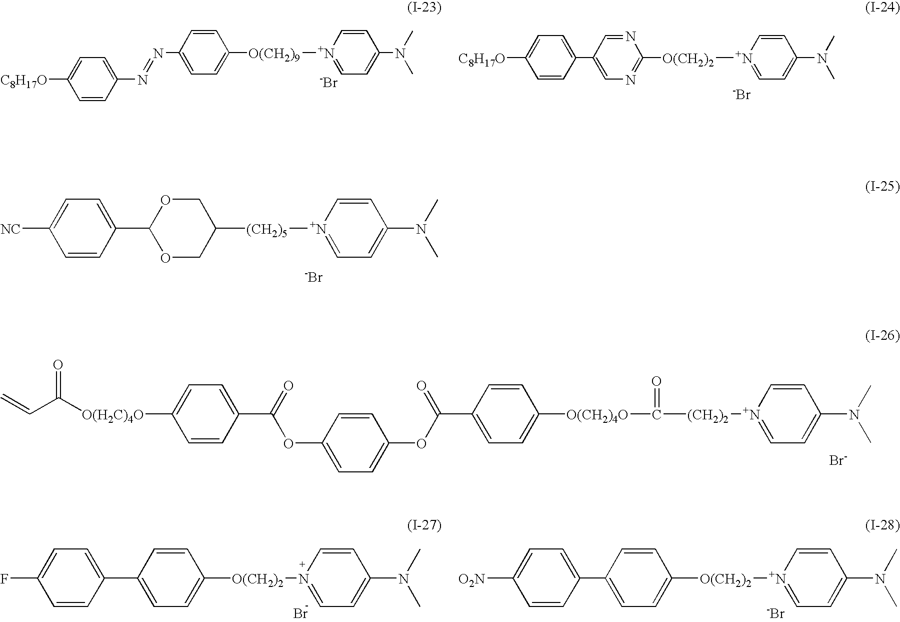

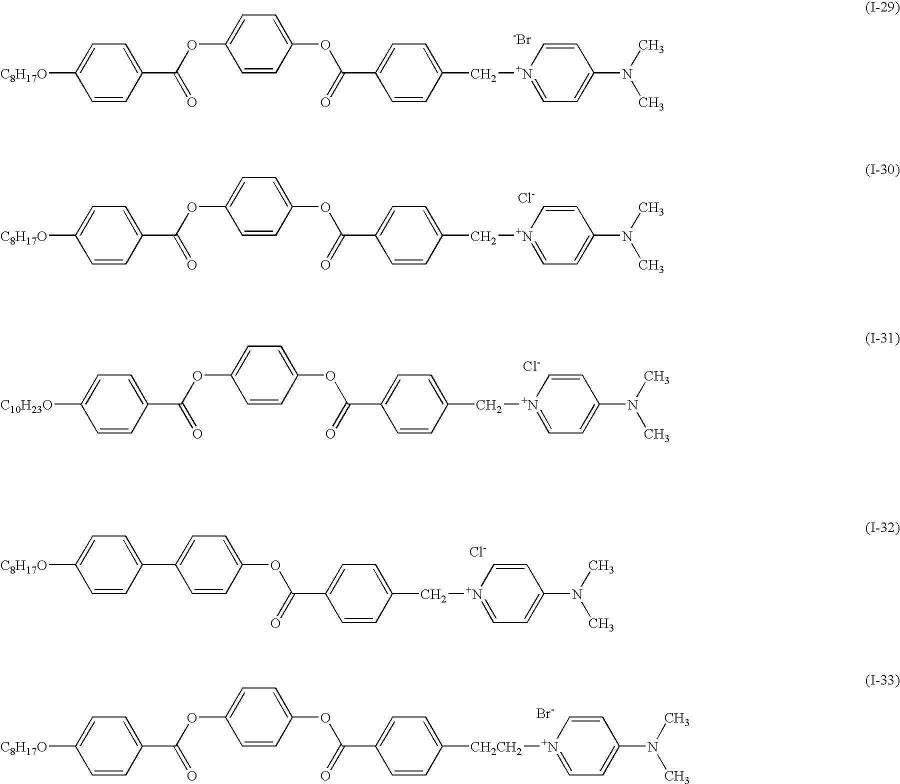

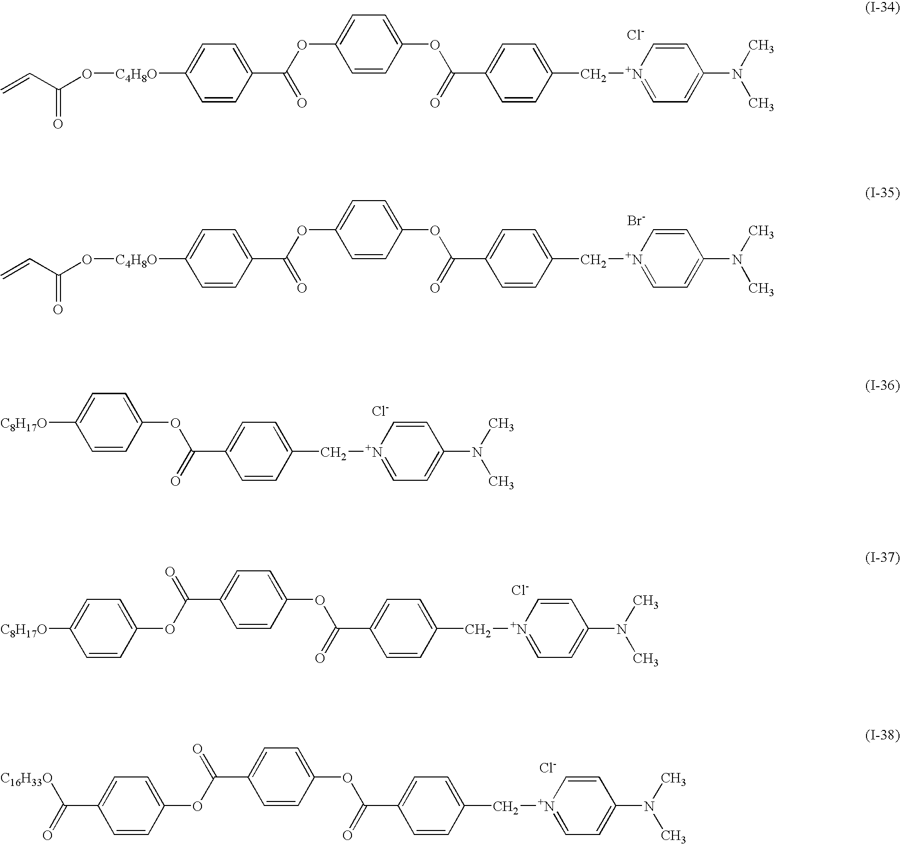

Pyridinium derivatives can be usually obtained by subjecting a pyridine ring to the alkylation (Menschutkin reaction).

A preferable range of the content of the pyridinium derivatives in the liquid crystalline composition varies depending on their use, but it is preferably 0.005 to 8% by weight, and more preferably 0.01 to 5% by weight in the liquid crystalline composition (liquid crystalline composition without a solvent in the case of preparing as a coating solution).

[Air Interface Vertical Alignment Material]

For the air interface vertical alignment material used in the invention, a fluoro-aliphatic group-containing polymer having a fluoro-aliphatic group and at least one or more hydrophilic group selected from a group of a carboxyl group (—COOH), a sulfo group (—SO₃H), a phosphonoxy group {—OP(═O)(OH)₂} and a salt thereof (hereinafter referred to as the ‘fluorine-based polymer’), or a fluorine-containing compound represented by Formula (III), is favorably used.

First, the fluorine-containing polymer will be described.

The fluorine-containing polymer used in the invention is characterized in that it contains a fluoro-aliphatic group and at least one or more hydrophilic group selected from a group of a carboxyl group (—COOH), a sulfo group (—SO₃H), a phosphonoxy group {—OP(═O) (OH)₂} and salts thereof. Examples of the polymers, as described in Otsu, T. “Revised. The Chemistry of Polymer Synthesis”, Kagaku Dojin, p. 1-4 (1968), include polyolefins, polyesters, polyamides, polyimides, polyurethanes, polycarbonates, polysulfones, polycarbonates, polyethers, polyacetals, poly ketones, polyphenylene oxides, polyphenylene sulfides, polyarylates, polytetrafluoroethylenes (PTFE), polyvinylidene fluorides, a cellulose derivatives and the like. The fluorine-containing polymers are preferably polyolefins.

Such the fluorine-containing polymer is a polymer having a fluoro-aliphatic group in its side chain. The fluorine-containing polymer preferably has 1 to 12 carbon atoms, and more preferably has 6 to 10 carbon atoms. The aliphatic group may be a chained group or a ring group. When the aliphatic group is a chained group, it may be a linear chain or a branched chain. Among them, a linear chain fluoro-aliphatic group having 6 to 10 carbon atoms is preferred. The degree of substitution by a fluorine atom is not particularly limited, but 50% or more of the hydrogen atoms in the aliphatic group are preferably substituted by a fluorine atom, and a substitution degree of 60% or more is further preferred. The fluoro-aliphatic group is contained in the side chain bonded with the main chain of a polymer introduced by an ester bond, an amide bond, an imide bond, a urethane bond, an ether bond, a thioether bond, aromatic ring or the like. One of the fluoro-aliphatic groups is derived from a fluoro-aliphatic compound prepared by the telomerization method (also referred to as a telomer method) or the oligomerization method (also referred to as an oligomer method). The preparation method of the fluoro-aliphatic compound is described, for example, in N. Ishikawa, “Synthesis and Function of Fluorine Compound”, CMC, p. 117-118 (1987) or Hudlicky, M. & Pavlath, A. E., “Chemistry of Organic Fluorine Compounds II” Monograph 187, Edited by Milos Hudlicky and Attila E. Pavlath, American Chemical Society p. 747-752 (1995). The telomerization method is a process in which an alkyl halide having a large chain transfer constant such as an iodide is used as a telogen to conduct radical polymerization of a fluorine-containing vinyl compound such as tetrafluoroethylene to synthesize a telomer (exemplified in Scheme-1).

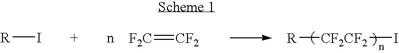

The obtained iodine-terminated telomer is usually subjected to an appropriate terminal chemical modification, such as those shown by Scheme 2, and thereby converted to fluoro-aliphatic compounds. These compounds are further converted, if necessary, into desired monomer structures, which are then used in preparing a fluorine-containing polymer.

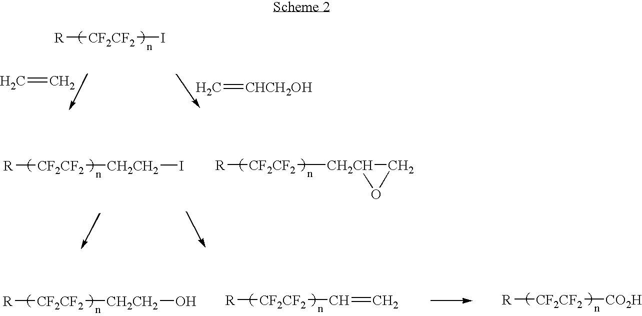

Specific examples of the monomer used for preparation of the fluorine-containing polymer useful in the invention are shown below, but the invention is not limited to these specific examples in any way.

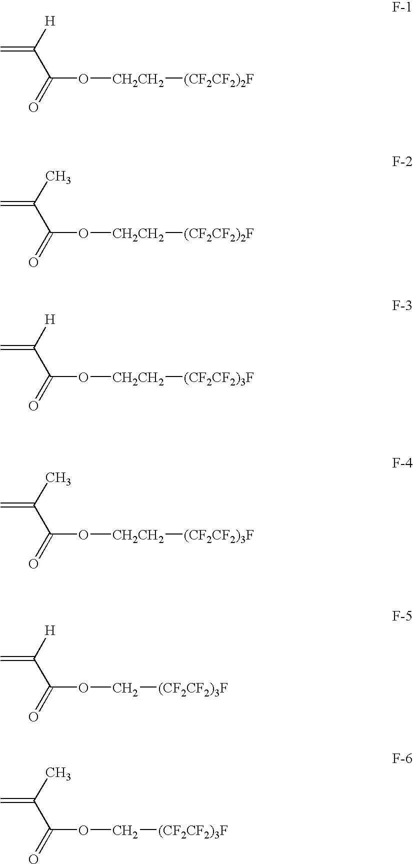

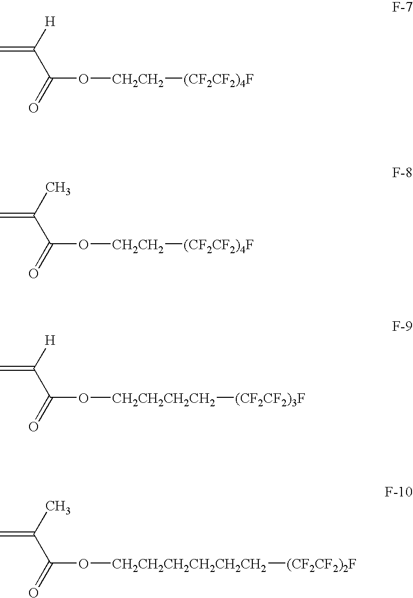

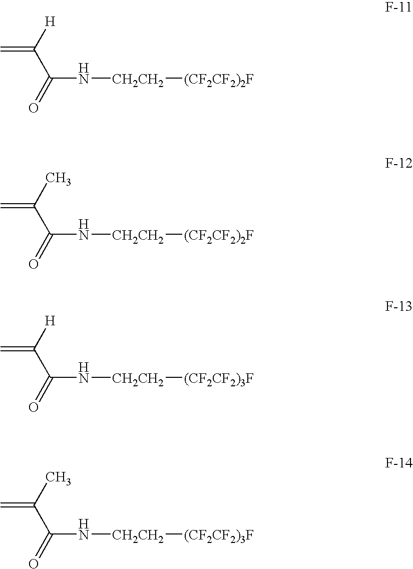

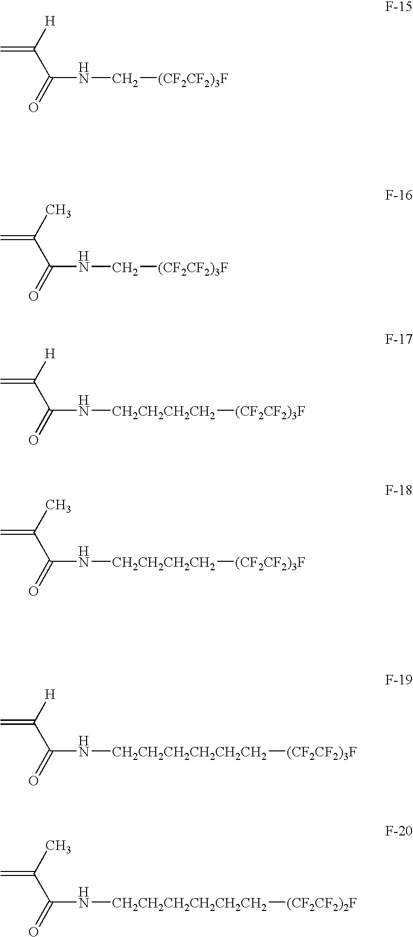

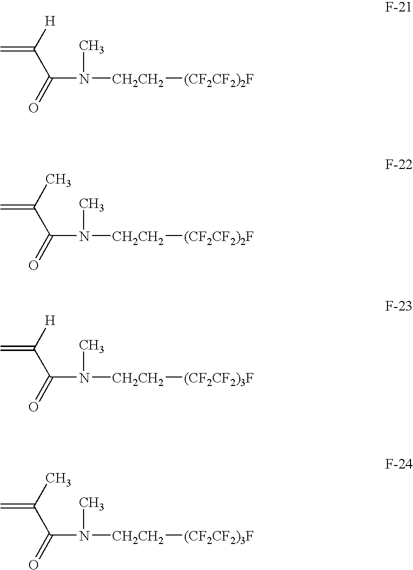

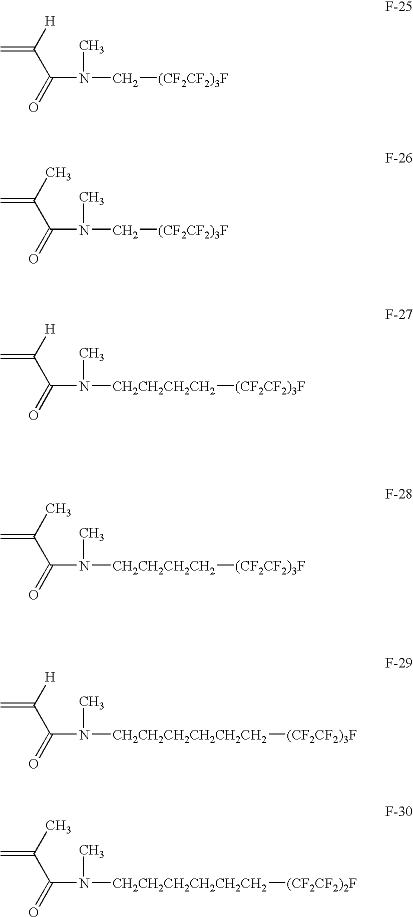

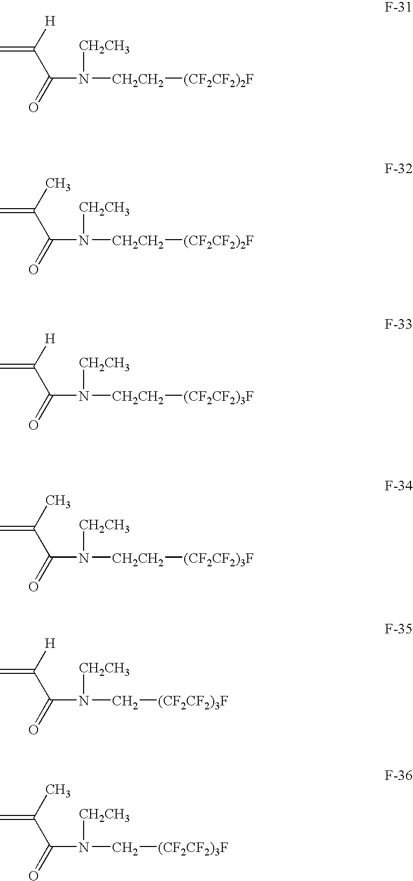

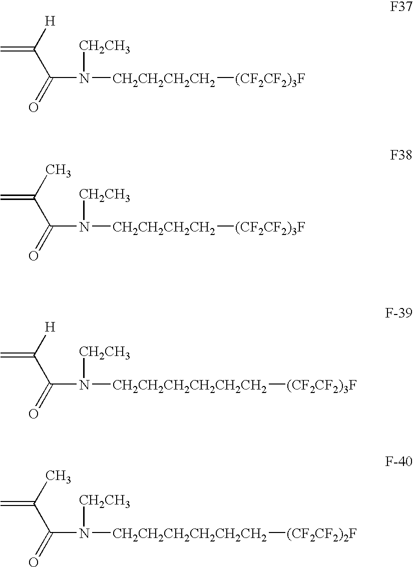

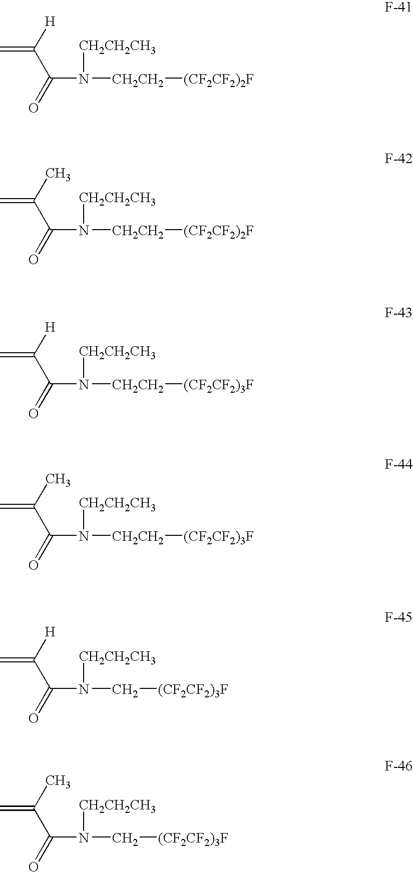

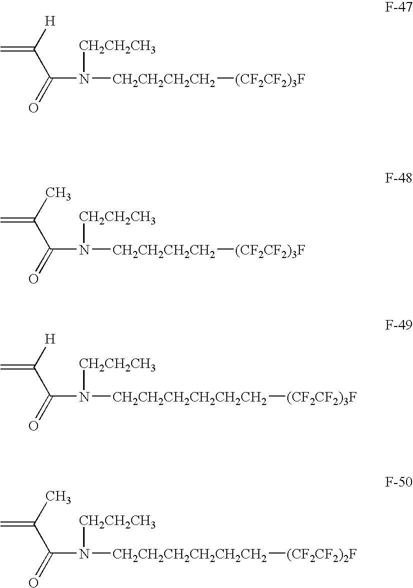

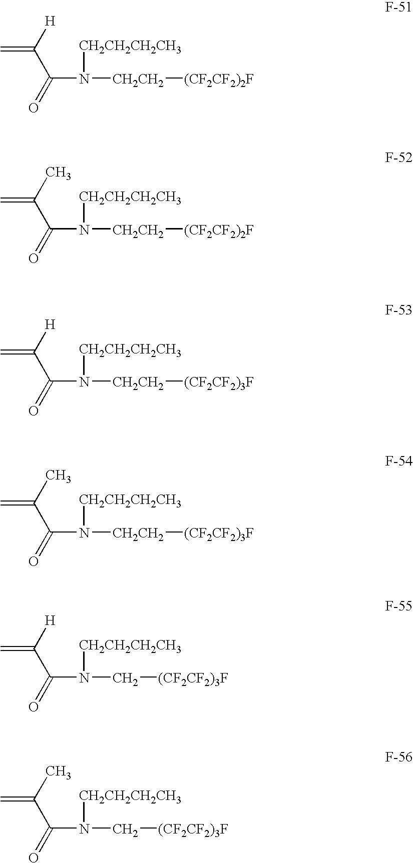

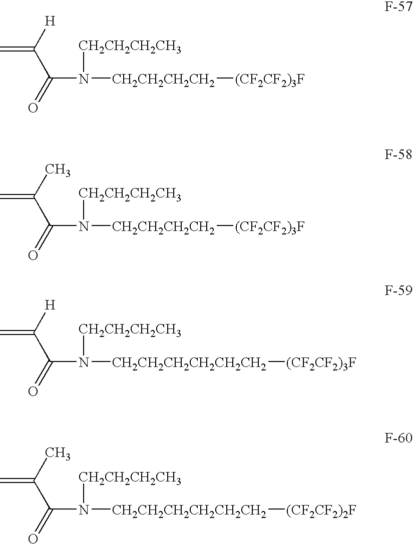

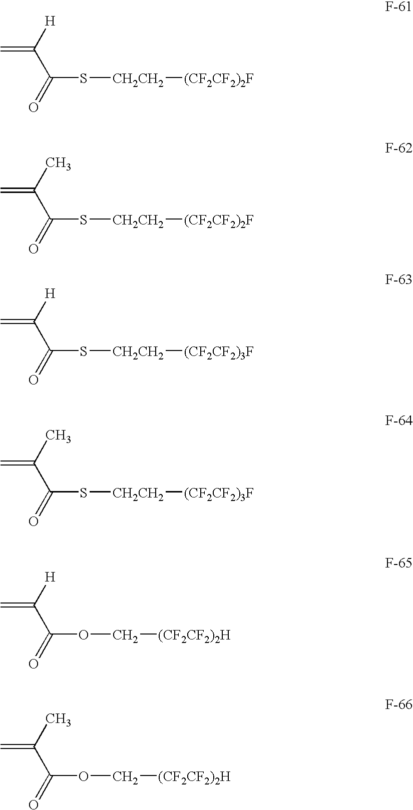

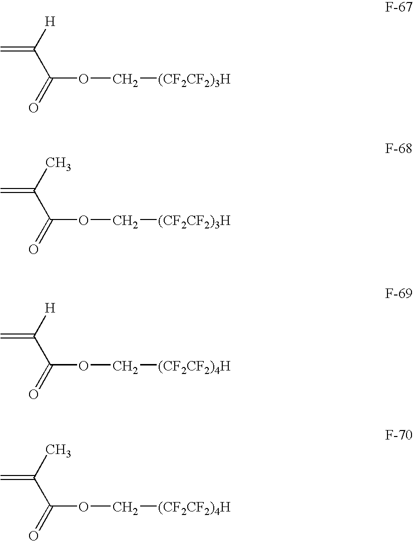

One embodiment of the fluorine-containing polymer used in the invention is a copolymer of a repeating unit derived from a fluoro-aliphatic group-containing monomer (sometimes referred to as a ‘fluorine-containing monomer’) and a repeating unit having a hydrophilic group represented by the following Formula (II).

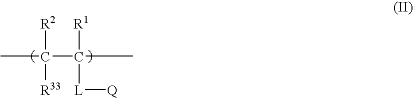

In Formula (II), R¹, R² and R³³ are each independently a hydrogen atom or a substituent. Q is a carboxyl group (—COOH) or its salts, a sulfo group (—SO₃H) or its salts, or a phosphonoxy group {—OP(═O) (OH)₂} or its salts. L is an arbitrary group selected from the following linking groups or a divalent linking group formed of combination of two or more kinds thereof.

(Group of Linking Groups)

A single bond, —O—, —CO—, —NR^{b}— (wherein R^{b} is a hydrogen atom, an alkyl group, an aryl group or an aralkyl group), —S—, —SO₂—, —P(═O) (OR^{f})— (wherein R^{f} is an alkyl group, an aryl group or an aralkyl group), an alkylene group and an arylene group.

In Formula (II), R¹, R² and R³³ are each independently a hydrogen atom or a substituent selected from the following group of the substituents.

(Group of Substituents)

An alkyl group (an alkyl group having preferably 1 to 20 carbon atoms, more preferably 1 to 12 carbon atoms, and even more preferably 1 to 8 carbon atoms such as a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.); an alkenyl group (an alkenyl group having preferably 2 to 20 carbon atoms, more preferably 2 to 12 carbon atoms, and even more preferably 2 to 8 carbon atoms such as a vinyl group, an aryl group, a 2-butenyl group, a 3-pentenyl group, etc.); an alkynyl group (an alkynyl group having preferably 2 to 20 carbon atoms, more preferably 2 to 12 carbon atoms, and even more preferably 2 to 8 carbon atoms such as a propargyl group, a 3-pentynyl group, etc.); an aryl group (an aryl group having preferably 6 to 30 carbon atoms, more preferably 6 to 20 carbon atoms, and even more preferably 6 to 12 carbon atoms such as a phenyl group, a p-methylphenyl group, a naphthyl group, etc.); an aralkyl group (an aralkyl group having 7 to 30 carbon atoms, more preferably 7 to 20 carbon atoms, and even more preferably 7 to 12 carbon atoms such as a benzyl group, a phenethyl group, a 3-phenylpropyl group, etc.); a substituted or unsubstituted amino group (an amino group having preferably 0 to 20 carbon atoms, more preferably 0 to 10 carbon atoms, and even more preferably 0 to 6 carbon atoms such as an unsubstituted amino group, a methylamino group, a dimethylamino group, a diethylamino group, an anilino group, etc.);

an alkoxy group (an alkoxy group having preferably 1 to 20 carbon atoms, more preferably 1 to 16 carbon atoms, and even more preferably 1 to 10 carbon atoms such as a methoxy group, an ethoxy group, a butoxy group, etc.); an alkoxycarbonyl group (an alkoxycarbonyl group having preferably 2 to 20 carbon atoms, more preferably 2 to 16 carbon atoms, and even more preferably 2 to 10 carbon atoms such as a methoxycarbonyl group, an ethoxycarbonyl group, etc.); an acyloxy group (an acyloxy group having preferably 2 to 20 carbon atoms, more preferably 2 to 16 carbon atoms, and even more preferably 2 to 10 carbon atoms such as an acetoxy group, a benzoyloxy group, etc.); an acylamino group (an acylamino group having preferably 2 to 20 carbon atoms, more preferably 2 to 16 carbon atoms, and even more preferably 2 to 10 carbon atoms such as an acetylamino group, a benzoylamino group, etc.); an alkoxycarbonylamino group (an alkoxycarbonylamino group having preferably 2 to 20 carbon atoms, more preferably 2 to 16 carbon atoms, and even more preferably 2 to 12 carbon atoms such as methoxycarbonylamino group, etc.); an aryloxycarbonylamino group (an aryloxycarbonylamino group having preferably 7 to 20 carbon atoms, more preferably 7 to 16 carbon atoms, and even more preferably 7 to 12 carbon atoms such as phenyloxycarbonylamino group, etc.); a sulfonylamino group (a sulfonylamino group having preferably 1 to 20 carbon atoms, more preferably 1 to 16 carbon atoms, and even more preferably 1 to 12 carbon atoms such as a methanesulfonylamino group, a benzenesulfonylamino group, etc.); a sulfamoyl group (a sulfamoyl group having preferably 0 to 20 carbon atoms, more preferably 0 to 16 carbon atoms, and even more preferably 0 to 12 carbon atoms such as a sulfamoyl group, a methylsulfamoyl group, a dimethylsulfamoyl group, a phenylsulfamoyl group, etc.); a carbamoyl group (a carbamoyl group having preferably 1 to 20 carbon atoms, more preferably 1 to 16 carbon atoms, and even more preferably 1 to 12 carbon atoms such as an unsubstituted carbamoyl group, a methylcarbamoyl group, a diethylcarbamoyl group, a phenylcarbamoyl group, etc.);

an alkylthio group (an alkylthio group having preferably 1 to 20 carbon atoms, more preferably 1 to 16 carbon atoms, and even more preferably 1 to 12 carbon atoms such as a methylthio group, an ethylthio group, etc.); an arylthio group (an arylthio group having preferably 6 to 20 carbon atoms, more preferably 6 to 16 carbon atoms, and even more preferably 6 to 12 carbon atoms such as a phenylthio group, etc.); a sulfonyl group (a sulfonyl group having preferably 1 to 20 carbon atoms, more preferably 1 to 16 carbon atoms, and even more preferably 1 to 12 carbon atoms such as a mesyl group, a tosyl group, etc.); a sulfinyl group (a sulfinyl group having preferably 1 to 20 carbon atoms, more preferably 1 to 16 carbon atoms, and even more preferably 1 to 12 carbon atoms such as a methanesulfinyl group, a benzenesulfinyl group, etc.); a ureido group (a ureido group having preferably 1 to 20 carbon atoms, more preferably 1 to 16 carbon atoms, and even more preferably 1 to 12 carbon atoms such as an unsubstituted ureido group, a methylureido group, a phenylureido group, etc.); a phosphoric amido group (a phosphoric amido group having preferably 1 to 20 carbon atoms, more preferably 1 to 16 carbon atoms, and even more preferably 1 to 12 carbon atoms such as a diethylphosphoric amido group, a phenylphosphoric amido group, etc.); a hydroxyl group; a mercapto group; a halogen atom (e.g., a fluorine atom, a chlorine atom, a bromine atom and an iodine atom); a cyano group; a sulfo group; a carboxyl group; a nitro group; a hydroxamic acid group; a sulfino group; a hydrazino group; an imino group; a heterocyclic group (a heterocyclic group having preferably 1 to 30 carbon atoms, and more preferably 1 to 12 carbon atoms such as heterocyclic group containing heteroatoms such as a nitrogen atom, an oxygen atom, a sulfur atom, e.g., an imidazolyl group, a pyridyl group, a quinolyl group, a furyl group, a piperidine group, a morpholino group, a benzoxazolyl group, a benzimidazolyl group, a benzthiazolyl group, etc.); a silyl group (a silyl group having preferably 3 to 40 carbon atoms, more preferably 3 to 30 carbon atoms, and even more preferably 3 to 24 carbon atoms such as a trimethylsilyl group, a triphenylsilyl group, etc.). These substituents may be further substituted with these substituents. In addition, when two or more substituents exist, they may be the same as or different from each other. Further, they may be bonded to each other to form a ring, if possible.

Preferably, R¹, R² and R³³ are each independently a hydrogen atom, an alkyl group, a halogen group (e.g., a fluorine atom, a chlorine atom, a bromine atom, an iodine atom, etc.) or a group represented by -L-Q to be described below, more preferably a hydrogen atom, an alkyl group having 1 to 6 carbon atoms, a chlorine atom or a group represented by -L-Q, particularly preferably a hydrogen atom, an alkyl group having 1 to 4 carbon atoms, and most preferably a hydrogen atom or an alkyl group having 1 to 2 carbon atoms. Specific examples of the alkyl group include a methyl group, an ethyl group, an n-propyl group, an n-butyl group, a sec-butyl group and the like. The alkyl group may have a suitable substituent. Examples of the substituent include a halogen atom, an aryl group, a heterocyclic group, an alkoxyl group, an aryloxy group, an alkylthio group, an arylthio group, an acyl group, a hydroxyl group, an acyloxy group, an amino group, an alkoxycarbonyl group, an acylamino group, an oxycarbonyl group, a carbamoyl group, a sulfonyl group, a sulfamoyl group, a sulfonamido group, a sulforyl group, a carboxyl group and the like. Further, for the number of carbon atoms in the alkyl group, carbon atoms in the substituents are not considered. Hereinafter, it is also applied to the number of carbon atoms in other groups.

L is a divalent linking group selected from the above-mentioned linking groups, or a divalent linking group formed by combination of two or more kinds thereof to form a divalent linking group. Among the above-mentioned group of the linking groups, R^{b} of —NR^{b}— is a hydrogen atom, an alkyl group, an aryl group or an aralkyl group, and preferably a hydrogen atom or an alkyl group. Further, R^{f} of —PO(OR^{f})— is an alkyl group, an aryl group or an aralkyl group, and preferably an alkyl group. When R^{b} and R^{f} are an alkyl group, an aryl group or an aralkyl group, the number of carbon atoms is the same as described for the ‘group of the substituents’. Examples of L preferably include a single bond, —O—, —CO—, —NR^{b}—, —S—, —SO₂—, an alkylene group or an arylene group, and particularly preferably include —CO—, —O—, —NR^{b}, an alkylene group or an arylene group. When L is an alkylene group, it is an alkylene group having preferably 1 to 10 carbon atoms, more preferably 1 to 8 carbon atoms, and even more preferably 1 to 6 carbon atoms. Specific examples of the particularly preferable alkylene group include a methylene group, an ethylene group, a trimethylene group, a tetrabutylene group, a hexamethylene group and the like. When L is an arylene group, the number of carbon atoms in an arylene group is preferably 6 to 24, more preferably 6 to 18, and even more preferably 6 to 12. Specific examples of the particularly preferable arylene group include a phenylene group, a naphthalene group and the like. When L comprises a divalent linking group obtained by combination of an alkylene group and an arylene group, the number of the aralkylene groups is preferably 7 to 34, more preferably 7 to 26, and even more preferably 7 to 16. Specific examples of the particularly preferable aralkylene group include a phenylenemethylene group, a phenyleneethylene group, a methylenephenylene group and the like. The group mentioned as L may have a suitable substituent. Such the substituent may be the same substituent as the above-mentioned for the substituent in R¹, R² and R³³.

Hereinbelow, the specific structures of L are exemplified.

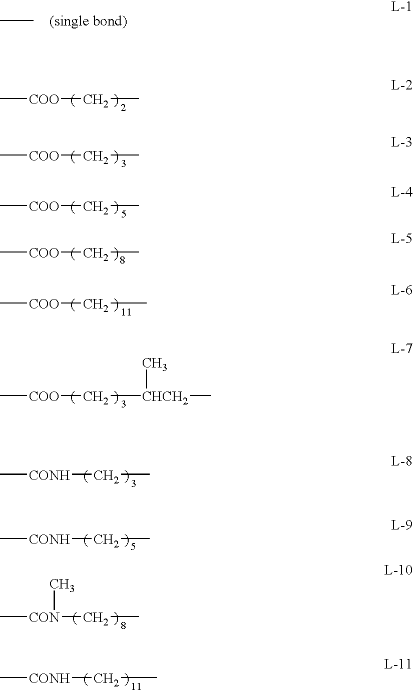

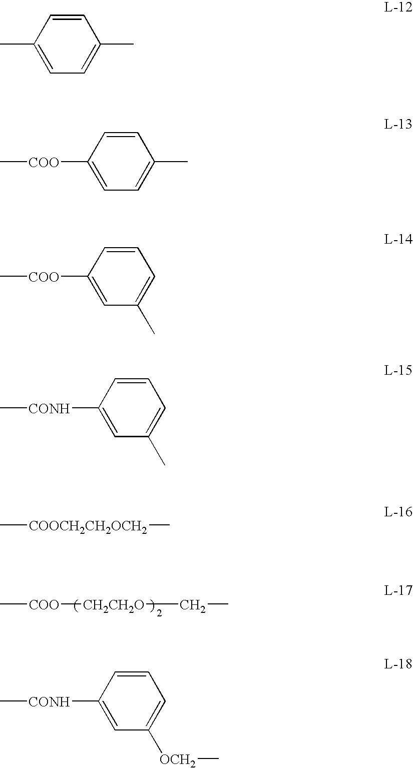

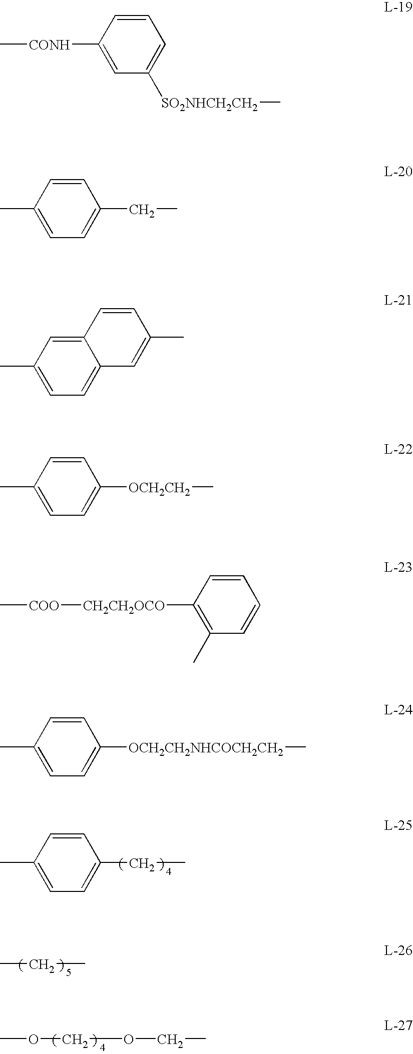

In Formula (II), Q is a carboxyl group and a salt thereof (e.g., a lithium salt, a sodium salt, a potassium salt, an ammonium salt (e.g., ammonium, tetramethyl ammonium, trimethyl-2-hydroxyethyl ammonium, tetrabutyl ammonium, trimethylbenzyl ammonium, dimethylphenyl ammonium, etc.), a pyridinium salt, etc.), a sulfo group and a salt thereof (examples of the cation forming salt are the same as the salts disclosed for the carboxyl group), a phosphonoxy group and a salt thereof (examples of the cation forming salt are the same salts disclosed for the carboxyl group). Q is further preferably a carboxyl group, a sulfo group or a phospho group, and particularly preferably a carboxyl group or a sulfo group.

The above-mentioned fluorine-containing polymer may contain one kind of the repeating unit represented by Formula (II), and may also contain two or more kinds thereof. Moreover, the fluorine-containing polymer may contain one kind or two or more kinds of other repeating units in addition to the above-mentioned each repeating unit. The other repeating unit is not particularly limited, but typically a repeating unit derived from a radically polymerizable monomer may be mentioned as a preferable example. Hereinafter, specific examples of the monomer to be derived to other repeating unit will be mentioned. The fluorine-containing polymer may contain a repeating unit derived from one kind or two or more kinds of monomers selected from the following group of the monomers.

Group of Monomers

(1) Alkenes:

ethylene, propylene, 1-butene, isobutene, 1-hexene, 1-dodecene, 1-octadecene, 1-eicosene, hexafluoropropene, vinylidene fluoride, chlorotrifluoroethylene, 3,3,3-trifluoropropylene, tetrafluoroethylene, vinyl chloride, vinylidene chloride and the like;

(2) Dienes:

1,3-butadiene, isoprene, 1,3-pentadiene, 2-ethyl-1,3-butadiene, 2-n-propyl-1,3-butadiene, 2,3-dimethyl-1,3-butadiene, 2-methyl-1,3-pentadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chlorobutadiene, 2-fluoro-1,3-butadiene, 2,3-chloro-1,3-butadiene, 1,1,2-trichloro-1,3-butadiene and 2-cyano-1,3-butadiene, 1,4-divinyl cyclohexane and the like;

(3) Derivatives of α,β-unsaturated carboxylic acid:

(3a) Alkyl acrylates:

methyl acrylate, ethyl acrylate, n-propyl acrylate, isopropyl acrylate, n-butyl acrylate, isobutyl acrylate, sec-butyl acrylate, tert-butyl acrylate, amyl acrylate, n-hexyl acrylate, cyclohexyl acrylate, 2-ethylhexyl acrylate, n-octyl acrylate, tert-octyl acrylate, dodecyl acrylate, phenyl acrylate, benzyl acrylate, 2-chloroethyl acrylate, 2-bromoethyl acrylate, 4-chlorobutyl acrylate, 2-cyanoethyl acrylate, 2-acetoxyethyl acrylate, methoxybenzyl acrylate, 2-chlorocyclohexyl acrylate, furfuryl acrylate, tetrahydrofurfuryl acrylate, 2-methoxyethyl acrylate, ω-methoxypolyethyleneglycol acrylate (number of added moles of polyoxyethylene: n=2 to 100), 3-methoxybutyl acrylate, 2-ethoxyethyl acrylate, 2-butoxyethyl acrylate, 2-(2-butoxyethoxy)ethyl acrylate, 1-bromo-2-methoxyethyl acrylate, 1,1-dichloro-2-ethoxyethyl acrylate, glycidylacrylate and the like;

(3b) Alkyl methacrylates:

methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, n-hexyl methacrylate, cyclohexyl methacrylate, 2-ethylhexyl methacrylate, n-octyl methacrylate, stearyl methacrylate, benzyl methacrylate, phenyl methacrylate, allyl methacrylate, furfuryl methacrylate, tetrahydrofurfuryl methacrylate, cresyl methacrylate, naphthyl methacrylate, 2-methoxyethyl methacrylate, 3-methoxybutyl methacrylate, ω-methoxypolyethyleneglycol methacrylate (number of added moles of polyoxyethylene: n=2 to 100), 2-acetoxyethyl methacrylate, 2-ethoxyethyl methacrylate, 2-butoxyethyl methacrylate, 2-(2-butoxyethoxy)ethyl methacrylate, glycidyl methacrylate, 3-trimethoxysilylpropyl methacrylate, allyl methacrylate, 2-isocyanatoethyl methacrylate and the like;

(3c) Diesters of unsaturated polyvalence carboxylic acid:

dimethyl malate, dibutyl malate, dimethyl itaconate, dibutyl itaconate, dibutyl crotonate, dihexyl crotonate, diethyl fumarate, dimethyl fumarate and the like; and

(3d) Amides of α,β-unsaturated carboxylic acid:

N,N-dimethylacrylic amide, N,N-diethylacrylic amide, N-n-propylacrylic amide, N-tert-butylacrylic amide, N-tert-octyl methacrylamide, N-cyclohexylacrylic amide, N-phenylacrylic amide, N-(2-acetoacetoxyethyl)acrylic amide, N-benzylacrylic amide, N-acryloyl morpholine, diacetone acrylic amide, N-methylmaleimide and the like;

(4) Unsaturated nitriles:

acrylonitrile, methacrylonitrile and the like;

(5) Styrenes and their derivatives:

styrene, vinyl toluene, ethyl styrene, p-tert-butyl styrene, p-vinylbenzoic acid methyl., α-methyl styrene, p-chloromethyl styrene, vinylnaphthalene, p-methoxy styrene, p-hydroxymethyl styrene, p-acetoxy styrene and the like;

(6) Vinyl esters:

vinyl acetate, vinyl propionate, vinyl butyrate, vinyl isobutyrate, vinyl benzoate, vinyl salicylate, vinyl chloroacetate, vinyl methoxyacetate, vinyl phenylacetate and the like;

(7) Vinyl ethers:

methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, n-dodecyl vinyl ether, n-eicosyl vinyl ether, 2-ethylhexyl vinyl ether, cyclohexyl vinyl ether, fluorobutyl vinyl ether, fluorobutoxyethyl vinyl ether and the like; and

(8) Other polymerizable monomers:

N-vinyl pyrrolidone, methyl vinyl ketone, phenyl vinyl ketone, methoxyethyl vinyl ketone, 2-vinyl oxazoline, 2-isopropenyl oxazoline and the like.

Within the above-mentioned fluorine-containing polymer, the content of the fluoro-aliphatic group-containing monomer is preferably 5% by weight or more, more preferably 10% by weight or more, and even more preferably 30% by weight or more of the total content of the component monomer in the polymer. For the fluorine-containing polymer, the content of the repeating unit represented by Formula (II) is preferably 0.5% by weight or more of the total content of the component monomer in the polymer, more preferably 1 to 20% by weight or more, and even more preferably 1 to 10% by weight or more. The percent by weight may be easily changed as the value of the preferable range is changed according to the molecular weight of the monomer being used, thus by presenting the molar number of the functional group per unit weight of a polymer, an accurate content of the repeating unit represented by Formula (II) can be determined. In the case of using such notation, a preferable content of a hydrophilic group contained in the fluorine-containing polymer (Q in Formula (II)) is 0.1 mmol/g to 10 mmol/g, and more preferable content is 0.2 mmol/g to 8 mmol/g.

The weight average molecular weight of the fluorine-containing polymer used in the invention is preferably 1,000,000 or less, more preferably 500,000 or less, and even more preferably 100,000 or less. The weight average molecular weight can be measured in terms of polystyrene (PS) value by gel permeation chromatography (GPC).

A method for polymerization of the above-mentioned fluorine-containing polymer is not particularly limited, but a cationic polymerization or radical polymerization using a vinyl group, or an anionic polymerization can be mentioned. Among them, the radical polymerization is particularly preferred from the viewpoint of common use. For the polymerization initiator, a conventional compound such as a radical thermopolymerization initiator or radical photopolymerization initiator can be used, but particularly preferably a radical thermopolymerization initiator is used. Herein, the radical thermopolymerization initiator is a compound which generates radical by heating to a temperature of decomposition temperature or more. Examples of the radical thermopolymerization initiator include dioxy peroxides (acetyl peroxides, benzoyl peroxides, etc.), keton peroxides (methylethyl ketone peroxides, cyclohexanone peroxides, etc.), hydroperoxides (hydrogen peroxide, tert-butylhydroperoxide, cumenhydroperoxide, etc.), dialkyl peroxides (di-tert-butyl peroxide, dicumyl peroxide, dirauroyl peroxide, etc.), peroxy esters (tert-butylperoxyacetate, tert-butylperoxypivarate, etc.), azo compounds (azo-bis-isobutyronitrile, azo-bis-isovaleronitrile, etc.), persulfates (ammonium persulfate, sodium persulfate, potassium persulfate, etc.). These radical thermopolymerization initiators can be used alone or in combination of two or more kinds thereof.

The radical polymerization is not particularly limited, but any one of an emulsion polymerization, a suspension polymerization, a mass polymerization and a solution polymerization can be adopted. The solution polymerization which is a typical radical polymerization will be described in detail. The fundamentals of other polymerization methods are the same, and they are described, for example, in “Experimental Method for Polymer Synthesis, (Tokyo KAGAKU-DOJIN, 1981), and the like.

An organic solvent is used in carrying out the solution polymerization. The organic solvent can be arbitrarily selected as long as it does not impair the object and effect of the invention. The organic solvent is generally one having a boiling point within the range of 50 to 200° C. under atmospheric pressure, and an organic compound which may dissolve each constitutional component is preferred. Preferable examples of the organic solvent include alcohols such as isopropanol and butanol; ethers such as dibutyl ether, ethyleneglycol diemethyl ether, tetrahydrofuran and dioxane; ketones such as acetone, methylethyl ketone, methylisobutyl ketone and cyclohexanone; esters such as ethyl acetate, butyl acetate, amyl acetate and γ-butyrolactone; and aromatic hydrocarbons such as benzene, toluene and xylene. Further, the organic solvent can be used alone or in combination of two or more. In addition, from the viewpoint of dissolvability of a monomer or a produced polymer, a water-mixed organic solvent, in which water is used in combination with the organic solvent, may be also employed.

In addition, the conditions for solution polymerization are not particularly limited, but it is preferable, for example, that the temperature is within the range of 50 to 200° C. and the duration time for heating is 10 minutes to 30 hours. Further, in order not to deactivate the generated radicals, it is preferable to conduct inert gas purge surely during the solution polymerization, but also prior to the solution polymerization initiation. For the inert gas, a typical nitrogen gas can be preferably used.

In order to obtain the above-mentioned fluorine-containing polymer within a preferable molecular weight range, a radical polymerization method using a chain transfer agent is particularly effective. For the chain transfer agent, mercaptans (e.g., octylmercaptan, decylmercaptan, dodecylmercaptan, tert-dodecylmercaptan, octadecylmercaptan, thiophenol, p-nonylthiophenol, etc.), polyalkyl halides (e.g., carbon tetrachloride, chloroform, 1,1,1-trichloroethane, 1,1,1-tribromooctane, etc.), low-active monomers (α-methylstyrene, a α-methylstyrene dimer, etc.) can be used, and preferably mercaptan having 4 to 16 carbon atoms is preferably used. The use amount of the chain transfer agent is influenced by activity of the chain transfer agent, combination of the monomers, polymerization conditions, or the like, and is required to under precise control. However, with respect to the total molar number of the used monomer, the use amount of the chain transfer agent is preferably about 0.01 mol % to 50 mol %, more preferably 0.05 mol % to 30 mol %, and even more preferably 0.08 mol % to 25 mol %. The chain transfer agent may exist well together with the subjective monomers to be controlled for the degree of polymerization during the polymerization process, and its additive process is not particularly critical. The chain transfer agent may be added by dissolving in a monomer or added separately from the monomer.

Further, the fluorine-containing polymer of the invention preferably contains a polymerizable group as a substituent for fixating the alignment state of the discotic liquid crystalline compound.

Hereinbelow, specific examples of the fluorine-containing polymer which can be preferably used in the invention are shown, but the invention is not limited to these specific examples in any way. Numeral values herein (numeral values of a, b, c, d, etc.) are percent by weight values showing the compositional proportions of each monomers, respectively, and Mw is the weight average molecular weight in terms of PEO measured by GPC.

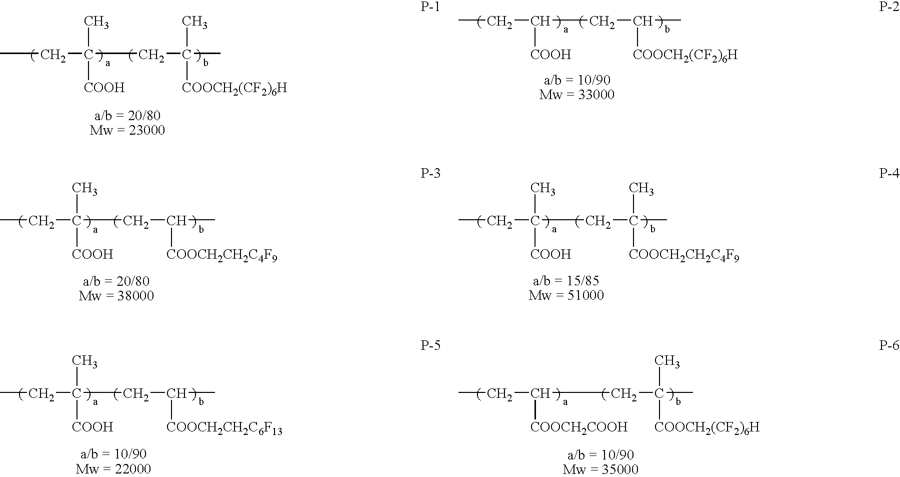

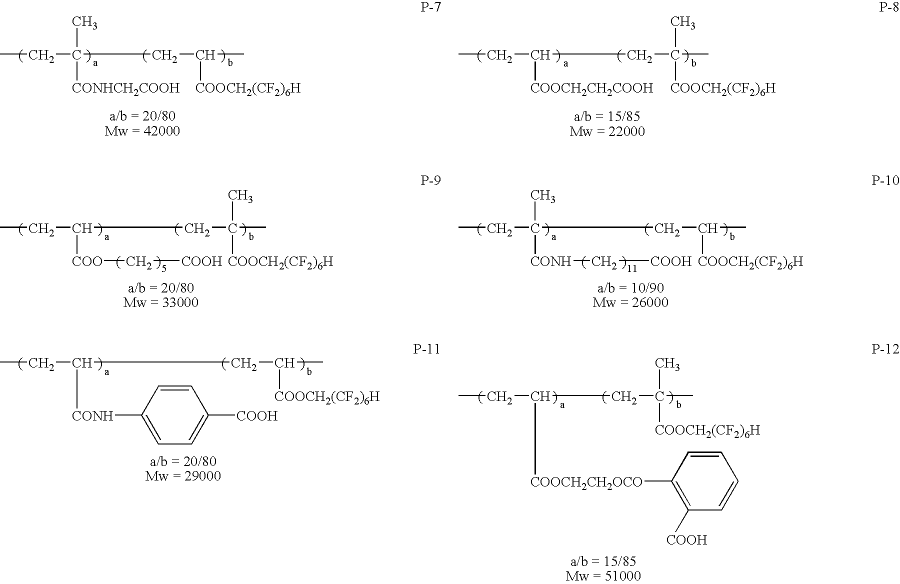

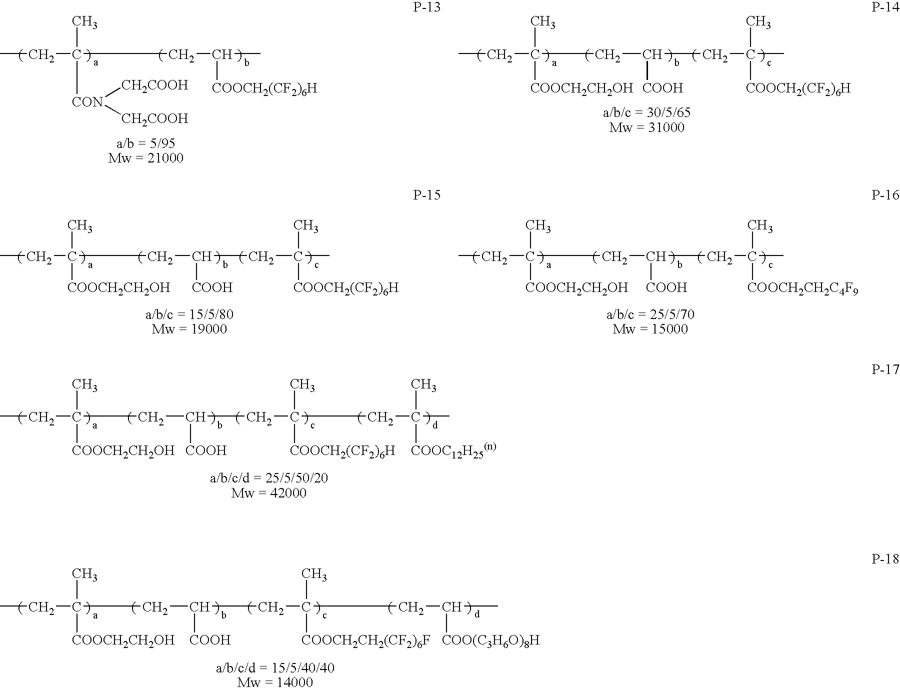

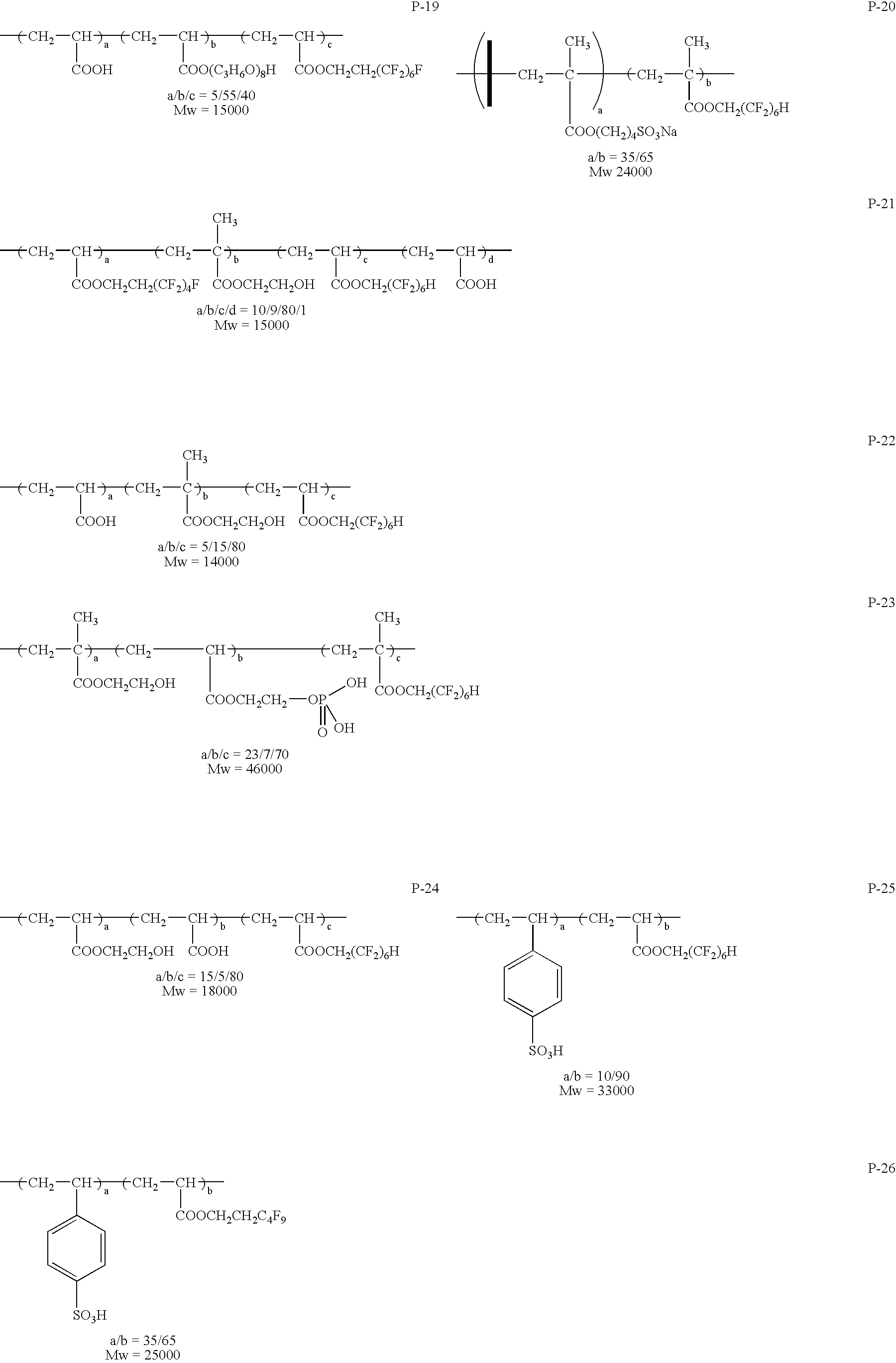

The fluorine-containing polymer used in the invention, can be prepared by a conventional and practical method. For example, first, to an organic solvent containing a given fluorine-containing monomer, a monomer having a group capable of hydrogen bonding and the like, a typical radical polymerization initiator is added, and the mixture is polymerized to prepare the fluorine-containing polymer. Further, in cases, other additional polymerizable unsaturated compounds are further added, and the same process is carried out to prepare the fluorine-containing polymer. With respect to the polymerizability of each monomer, a dropwise polymerization method that carries out polymerization while adding monomer and initiator dropwise into a reactor, or the like is effective for obtaining a polymer in a uniformed composition.

A preferable range of the content of the fluorine-containing polymer within the liquid crystalline composition (liquid crystalline composition without a solvent in the case of preparing as a coating solution) varies depending on their use, but it is preferably 0.005 to 8% by weight, more preferably 0.01 to 5% by weight, and even more preferably 0.05 to 1% by weight in the liquid crystalline composition. When the amount of the fluorine-containing polymer to be added is less than 0.005% by weight, its efficacy is insufficient, while when the amount to be added is more than 8% by weight, drying of the coating film is not carried out sufficiently, and the properties as an optic film is given a bad influence (e.g., uniformity of retardation, etc.).

Next, the fluorine-containing compound represented by Formula (III) which can be similarly used as an air interface vertical alignment material, will be described.

(R^{o})ₘₒ-L^{o}-(W)ₙₒ Formula (III)

wherein R^{o} is an alkyl group, an alkyl group having a CF₃ group at the end, or an alkyl group having a CF₂H group at the end. mo is an integer of 1 or greater. A plurality of R^{o} may be the same as or different from each other, but at least one R^{o}) is an alkyl group having a CF₃ group or a CF₂H group at the end. L^{o} is a (mo+no)-valent linking group, and W is a carboxyl group (—COOH) or a salt thereof, a sulfo group (—SO₃H) or a salt thereof, or a phosphonoxy group {—OP((═O) (OH)₂} or a salt thereof. no is an integer of 1 or greater.

In Formula (III), R^{o} functions as a hydrophobic group of a fluorine-containing compound. An alkyl group represented by R^{o} may be a substituted or unsubstituted alkyl group, may be a linear or branched chain. The alkyl group represented by R^{o} is preferably an alkyl group having 1 to 20 carbon atoms, more preferably an alkyl group having 4 to 16 carbon atoms, and particularly preferably an alkyl group having 6 to 16 carbon atoms. For the substituent, any one of the substituents exemplified as the following group D of the substituents is suitably used.

An alkyl group having a CF₃ group at the end represented by R^{o} is an alkyl group having preferably 1 to 20 carbon atoms, more preferably 4 to 16 carbon atoms, and even more preferably 4 to 8 carbon atoms. The alkyl group having a CF₃ group at the end is an alkyl group having the hydrogen atoms contained in the alkyl group to be substituted in partial or all with a fluorine atom. 50% or more of hydrogen atoms within the alkyl group to be substituted with fluorine atoms is preferred, a substitution degree of 60% or more is more preferred, and a substitution degree of 70% or more is even more preferred. The remaining hydrogen atoms may be further substituted with substituents exemplified as the following group D of the substituents. An alkyl group having a CF₂H group at the end represented by R^{o} is an alkyl group having preferably 1 to 20 carbon atoms, more preferably 4 to 16 carbon atoms, and even more preferably 4 to 8 carbon atoms. The alkyl group having a CF₂H group at the end is an alkyl group having the hydrogen atoms contained in the alkyl group to be substituted in partial or all with a fluorine atom. 50% or more of hydrogen atoms within the alkyl group to be substituted with fluorine atoms is preferred, a substitution degree of 60% or more is more preferred, and a substitution degree of 70% or more is even more preferred. The remaining hydrogen atoms may be further substituted with substituents exemplified as the following group D of the substituents. Examples of the alkyl group having a CF₃ group at the end or the alkyl group having a CF₂H group at the end represented by R^{o} are shown below.

R1: n-C₈F₁₇—

R2: n-C6F₁₃—

R3: n-C₄F₉—

R4: n-C₈F₁₇— (CH₂)₂—

R5: n-C₆F₁₃— (CH₂)₂—

R6: n-C₄F₉—(CH₂)₂—

R7: H—(CF₂)₈—

R8: H—(CF₂)₆—

R9: H—(CF₂)₄—

R10: H—(CF₂)₈—(CH₂)—

R11: H—(CF₂)₆—(CH₂)—

R12: H—(CF₂)₄—(CH₂)—

In formula (III), a (mo+no)-valent linking group represented by L^{o} is a linking group of at least two in combination selected from the group comprising an alkylene group, an alkenylene group, an aromatic group, a heterocyclic group, —CO—, —NR^{d}— (wherein R^{d} is an alkyl group having 1 to 5 carbon atoms or a hydrogen atom), —O—, —S—, —SO—, and —SO₂—.

In Formula (III), W is a carboxyl group (—COOH) or a salt thereof, a sulfo group (—SO₃H) or a salt thereof, or a phosphonoxy group {—OP(═O) (OH)₂} or a salt thereof. The preferable range of W is the same as of Q in Formula (II).

Among the fluorine-containing compound represented by Formula (III), a compound represented by the following Formula (III)-a or Formula (III)-b is preferred.

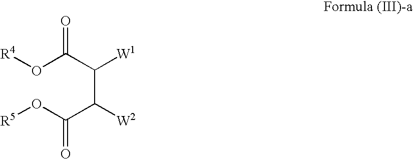

In Formula (III)-a, R⁴ and R⁵ are respectively an alkyl group, an alkyl group having a CF₃ group at the end, or an alkyl group having a CF₂H group at the end, but R⁴ and R cannot be an alkyl group at the same time. W¹ and W² are respectively a hydrogen atom, a carboxyl group (—COOH) or a salt thereof, a sulfo group (—SO₃H) or a salt thereof, a phosphonoxy group {—OP(═O) (OH)₂} or a salt thereof, or an alkyl group, an alkoxy group or an alkylamino group having a carboxyl group, a sulfo group or a phosphonoxy group as a substituent, but W¹ and W² cannot be a hydrogen atom at the same time.

(R⁶-L²-)ₘ₂(Ar¹)—W³ Formula (III)-b

wherein R⁶ is an alkyl group, an alkyl group having a CF₃ group at the end, or an alkyl group having a CF₂H group at the end, m2 is an integer of 1 or greater. A plurality of R⁶ may be the same as or different from each other, but at least one R⁶ is an alkyl group having a CF₃ group or a CF₂H group at the end. L² is a divalent linking group selected from a group consisting of an alkylene group, an aromatic group, —CO—, —NR′— (wherein R′ is an alkyl group having 1 to 5 carbon atoms or a hydrogen atom), —O—, —S—, —SO—, —SO₂—, or a combination thereof, and a plurality of L² may be the same as or different from each other. Ar¹ is an aromatic hydrocarbon ring or an aromatic heterocyclic ring, and W³ is a carboxyl group (—COOH) or a salt thereof, a sulfo group (—SO₃H) or a salt thereof, a phosphonoxy group {—OP(═O) (OH)₂} or a salt thereof, or an alkyl group, an alkoxy group or an alkylamino group having a carboxyl group, a sulfo group or a phosphonoxy group as a substituent.

First, Formula (III)-a will be described.

R⁴ and R⁵ have the same definition as for R^{o} in Formula (III), and their preferable ranges are also the same. A carboxyl group (—COOH) or a salt thereof, a sulfo group (—SO₃H) or a salt thereof, a phosphonoxy group {—OP(═O)(OH)₂} or a salt thereof represented by W¹ and W² have the same definition as W in Formula (III), and their preferable ranges are also the same. An alkyl group having a carboxyl group, a sulfo group or a phosphonoxy group as a substituent represented by W¹ and W² may be a linear or branched chain, and the alkyl group having 1 to 20 carbon atom is preferred, the alkyl group having 1 to 8 carbon atoms is more preferred, and the alkyl group having 1 to 3 carbon atoms is particularly preferred. The alkyl group having a carboxyl group, a sulfo group or a phosphonoxy group as a substituent may have at least one of a carboxyl group, a sulfo group or a phosphonoxy group, and the carboxyl group, the sulfo group and the phosphonoxy group have the same definition as the carboxyl group, the sulfo group and the phosphonoxy group represented by W in Formula (III), and their preferable ranges are also the same. The alkyl group having a carboxyl group, a sulfo group or a phosphonoxy group as a substituent may be substituted with other substituents in addition thereto, and for the substituent, any one of substituents exemplified as the following group D of the substituents can be suitably used. An alkoxy group having a carboxyl group, a sulfo group or a phosphonoxy group as a substituent represented by W¹ and W² may be a linear or branched chain, and the alkoxy group having 1 to 20 carbon atom is preferred, the alkoxy group having 1 to 8 carbon atoms is more preferred, and the alkoxy group having 1 to 4 carbon atoms is particularly preferred. The alkoxy group having a carboxyl group, a sulfo group or a phosphonoxy group as a substituent may have at least one of a carboxyl group, a sulfo group or a phosphonoxy group, and the carboxyl group, the sulfo group and the phosphonoxy group have the same definition as the carboxyl group, the sulfo group and the phosphonoxy group represented by W in Formula (III), and their preferable ranges are also the same. The alkoxy group having a carboxyl group, a sulfo group or a phosphonoxy group as a substituent may be substituted with other substituents in addition thereto, and for the substituent, any one of substituents exemplified as the following group D of the substituents can be suitably used. An alkylamino group having a carboxyl group, a sulfo group or a phosphonoxy group as a substituent represented by W¹ and W² may be a linear or branched chain, and the alkylamino group having 1 to 20 carbon atom is preferred, the alkylamino group having 1 to 8 carbon atoms is more preferred, and the alkylamino group having 1 to 4 carbon atoms is particularly preferred. The alkylamino group having a carboxyl group, a sulfo group or a phosphonoxy group as a substituent may have at least one of a carboxyl group, a sulfo group or a phosphonoxy group, and the carboxyl group, the sulfo group and the phosphonoxy group have the same definition as the carboxyl group, the sulfo group and the phosphonoxy group represented by W in Formula (III), and their preferable ranges are also the same. The alkylamino group having a carboxyl group, a sulfo group or a phosphonoxy group as a substituent may be substituted with other substituents in addition thereto, and for the substituent, any one of substituents exemplified as the following group D of the substituents can be suitably used.

W¹ and W² are particularly preferably a hydrogen atom or —(CH₂)ₙSO₃M (wherein n is 0 or 1), respectively. M is a cation, but in the case where the charge within the molecule becomes 0, M may not exist. Examples of the cation represented by M, a protonium ion, an alkali metal ion (a lithium ion, a sodium ion, a potassium ion, etc.), an alkaline-earth metal ion (a barium ion, a calcium ion, etc.), an ammonium ion and the like, can be preferably used. Among these, a protonium ion, a lithium ion, a sodium ion, a potassium ion and an ammonium ion are particularly preferred.

Next, Formula (III)-b will be described.

R⁶ has the same definition as R^{o} in Formula (III), and their preferable ranges are also the same. L² is preferably a linking group having total of 0 to 40 carbon atoms selected from a group consisting of an alkylene group having 1 to 12 carbon atoms, an aromatic group having 6 to 12 carbon atoms, —CO—, —NR—, —O—, —S—, —SO—, —SO₂—, or a combination thereof, and more preferably a linking group having total of 0 to 20 carbon atoms selected from a group consisting of an alkylene group having 1 to 8 carbon atoms, a phenyl group, —CO—, —NR—, —O—, —S—, —SO₂—, or a combination thereof. Ar¹ is preferably an aromatic hydrocarbon ring having 6 to 12 carbon atoms, and more preferably a benzene ring or a naphthalene ring. W³ is a carboxyl group (—COOH) or a salt thereof, a sulfo group (—SO₃H) or a salt thereof, a phosphonoxy group {—OP(═O) (OH)₂} or a salt thereof, or an alkyl group, an alkoxy group or an alkylamino group having a carboxyl group, a sulfo group or a phosphonoxy group as a substituent has the same definition as a carboxyl group (—COOH) or a salt thereof, a sulfo group (—SO₃H) or a salt thereof, a phosphonoxy group {—OP(═O) (OH)₂} or a salt thereof, or an alkyl group, an alkoxy group or an alkylamino group having a carboxyl group, a sulfo group or a phosphonoxy group as a substituent represented by W¹ and W² in Formula (III)-a, and their preferable ranges are also the same.

W³ is preferably a carboxyl group (—COOH) or a salt thereof, a sulfo group (—SO₃H) or a salt thereof, or an alkylamino group having a carboxyl group (—COOH) or a salt thereof, or a sulfo group (—SO₃H) or a salt thereof as a substituent, and particularly preferably SO₃M or CO₂M. M is a cation, but in the case where the charge within the molecule becomes 0, M may not exist. Examples of the cation represented by M, a protonium ion, an alkali metal ion (a lithium ion, a sodium ion, a potassium ion, etc.), an alkaline-earth metal ion (a barium ion, a calcium ion, etc.), an ammonium ion and the like, can be preferably used. Among these, a protonium ion, a lithium ion, a sodium ion, a potassium ion and an ammonium ion are particularly preferred.

In the specification, examples of the group D of the substituents include an alkyl group (an alkyl group having preferably 1 to 20 carbon atoms, more preferably 1 to 12 carbon atoms, and even more preferably 1 to 8 carbon atoms such as a methyl group, an ethyl group, an isopropyl group, a tert-butyl group, an n-octyl group, an n-decyl group, an n-hexadecyl group, a cyclopropyl group, a cyclopentyl group, a cyclohexyl group, etc.); an alkenyl group (an alkenyl group having preferably 2 to 20 carbon atoms, more preferably 2 to 12 carbon atoms, and even more preferably 2 to 8 carbon atoms such as a vinyl group, an aryl group, a 2-butenyl group, a 3-pentenyl group, etc.); an alkynyl group (an alkynyl group having preferably 2 to 20 carbon atoms, more preferably 2 to 12 carbon atoms, and even more preferably 2 to 8 carbon atoms such as a propargyl group, a 3-pentynyl group, etc.); an aryl group (an aryl group having preferably 6 to 30 carbon atoms, more preferably 6 to 20 carbon atoms, and even more preferably 6 to 12 carbon atoms such as a phenyl group, a p-methylphenyl group, a naphthyl group, etc.); a substituted or unsubstituted amino group (an amino group having preferably 0 to 20 carbon atoms, more preferably 0 to 10 carbon atoms, and even more preferably 0 to 6 carbon atoms such as an unsubstituted amino group, a methylamino group, a dimethylamino group, a diethylamino group, a dibenzylamino group, etc.);

an alkoxy group (an alkoxy group having preferably 1 to 20 carbon atoms, more preferably 1 to 12 carbon atoms, and even more preferably 1 to 8 carbon atoms such as a methoxy group, an ethoxy group, a butoxy group, etc.); an aryloxy group (an aryloxy group having preferably 6 to 20 carbon atoms, more preferably 6 to 16 carbon atoms, and even more preferably 6 to 12 carbon atoms such as a phenyloxy group, a 2-naphthyloxy group, etc.); an acyl group (an acyl group having 1 to 20 carbon atoms, more preferably 1 to 16 carbon atoms, and even more preferably 1 to 12 carbon atoms such as an acetyl group, a benzoyl group, a formyl group, a pivaloyl group, etc.); an alkoxycarbonyl group (an alkoxycarbonyl group having preferably 2 to 20 carbon atoms, more preferably 2 to 16 carbon atoms, and even more preferably 2 to 12 carbon atoms such as a methoxycarbonyl group, an ethoxycarbonyl group, etc.); an aryloxycarbonyl group (an aryloxycarbonyl group having preferably 7 to 20 carbon atoms, more preferably 7 to 16 carbon atoms, and even more preferably 7 to 10 carbon atoms such as phenyloxycarbonyl group, etc.); an acyloxy group (an acyloxy group having preferably 2 to 20 carbon atoms, more preferably 2 to 16 carbon atoms, and even more preferably 2 to 10 carbon atoms such as an acetoxy group, a benzoyloxy group, etc.);

an acylamino group (an acylamino group having preferably 2 to 20 carbon atoms, more preferably 2 to 16 carbon atoms, and even more preferably 2 to 10 carbon atoms such as an acetylamino group, a benzoylamino group, etc.); an alkoxycarbonylamino group (an alkoxycarbonylamino group having preferably 2 to 20 carbon atoms, more preferably 2 to 16 carbon atoms, and even more preferably 2 to 12 carbon atoms such as methoxycarbonylamino group, etc.); an aryloxycarbonylamino group (an aryloxycarbonylamino group having preferably 7 to 20 carbon atoms, more preferably 7 to 16 carbon atoms, and even more preferably 7 to 12 carbon atoms such as phenyloxycarbonylamino group, etc.); a sulfonylamino group (a sulfonylamino group having preferably 1 to 20 carbon atoms, more preferably 1 to 16 carbon atoms, and even more preferably 1 to 12 carbon atoms such as a methanesulfonylamino group, a benzenesulfonylamino group, etc.); a sulfamoyl group (a sulfamoyl group having preferably 0 to 20 carbon atoms, more preferably 0 to 16 carbon atoms, and even more preferably 0 to 12 carbon atoms such as a sulfamoyl group, a methylsulfamoyl group, a dimethylsulfamoyl group, a phenylsulfamoyl group, etc.); a carbamoyl group (a carbamoyl group having preferably 1 to 20 carbon atoms, more preferably 1 to 16 carbon atoms, and even more preferably 1 to 12 carbon atoms such as an unsubstituted carbamoyl group, a methylcarbamoyl group, a diethylcarbamoyl group, a phenylcarbamoyl group, etc.);

an alkylthio group (an alkylthio group having preferably 1 to 20 carbon atoms, more preferably 1 to 16 carbon atoms, and even more preferably 1 to 12 carbon atoms such as a methylthio group, an ethylthio group, etc.); an arylthio group (an arylthio group having preferably 6 to 20 carbon atoms, more preferably 6 to 16 carbon atoms, and even more preferably 6 to 12 carbon atoms such as a phenylthio group, etc.); a sulfonyl group (a sulfonyl group having preferably 1 to 20 carbon atoms, more preferably 1 to 16 carbon atoms, and even more preferably 1 to 12 carbon atoms such as a mesyl group, a tosyl group, etc.); a sulfinyl group (a sulfinyl group having preferably 1 to 20 carbon atoms, more preferably 1 to 16 carbon atoms, and even more preferably 1 to 12 carbon atoms such as a methanesulfinyl group, a benzenesulfinyl group, etc.); a ureido group (a ureido group having preferably 1 to 20 carbon atoms, more preferably 1 to 16 carbon atoms, and even more preferably 1 to 12 carbon atoms such as an unsubstituted ureido group, a methylureido group, a phenylureido group, etc.); a phosphoric amido group (a phosphoric amido group having preferably 1 to 20 carbon atoms, more preferably 1 to 16 carbon atoms, and even more preferably 1 to 12 carbon atoms such as a diethylphosphoric amido group, a phenylphosphoric amido group, etc.); a hydroxyl group; a mercapto group; a halogen atom (e.g., a fluorine atom, a chlorine atom, a bromine atom and an iodine atom); a cyano group; a sulfo group; a carboxyl group; a nitro group; a hydroxamic acid group; a sulfino group; a hydrazino group; an imino group; a heterocyclic group (a heterocyclic group having preferably 1 to 30 carbon atoms, and more preferably 1 to 12 carbon atoms such as heterocyclic group containing heteroatoms such as a nitrogen atom, an oxygen atom, a sulfur atom, e.g., an imidazolyl group, a pyridyl group, a quinolyl group, a furyl group, a piperidine group, a morpholino group, a benzoxazolyl group, a benzimidazolyl group, a benzthiazolyl group, etc.); a silyl group (a silyl group having preferably 3 to 40 carbon atoms, more preferably 3 to 30 carbon atoms, and even more preferably 3 to 24 carbon atoms such as a trimethylsilyl group, a triphenylsilyl group, etc.). These substituents may be further substituted with these substituents. In addition, when two or more substituents exist, they may be the same as or different from each other. Further, they may be bonded to each other to form a ring, if possible.

Further, for the fluorine-containing polymer of the invention, it is preferable to contain a polymerizable group as a substituent for fixating the alignment state of the discotic liquid crystalline compound.

Specific examples of the fluorine-containing polymer represented by Formula (III) used in the invention are shown below, but the invention is not limited to these specific examples in any way.

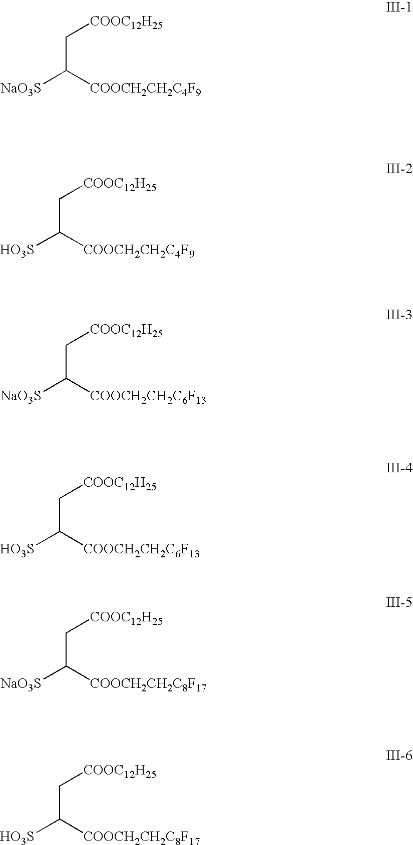

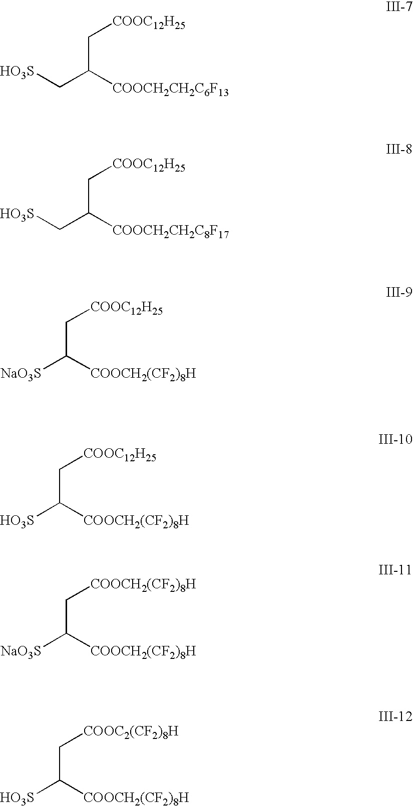

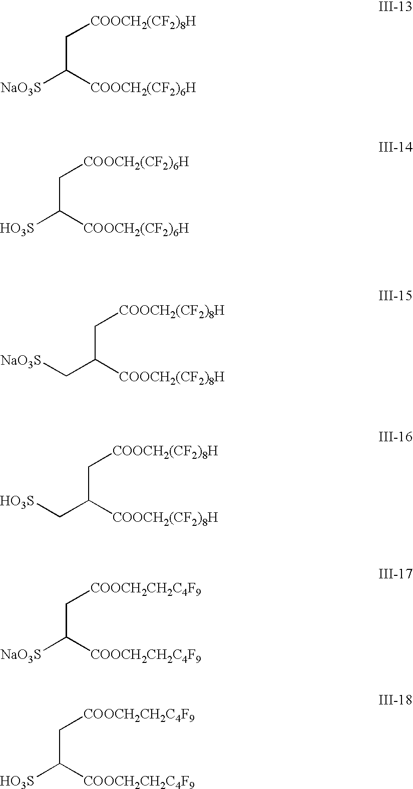

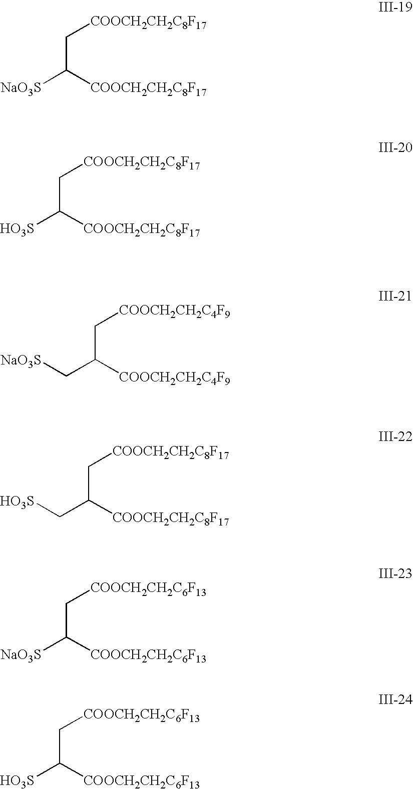

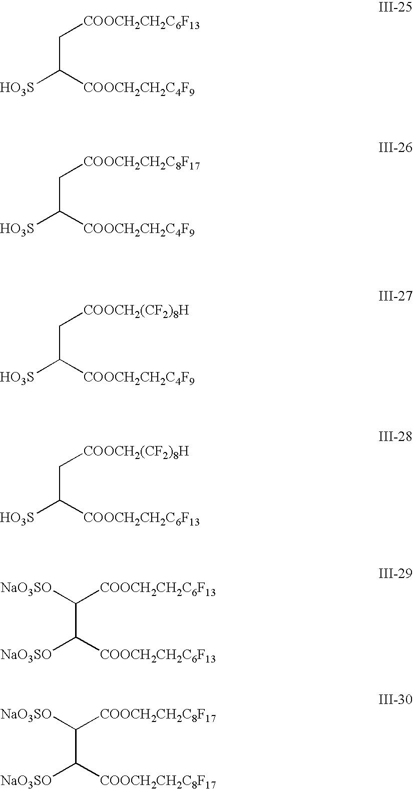

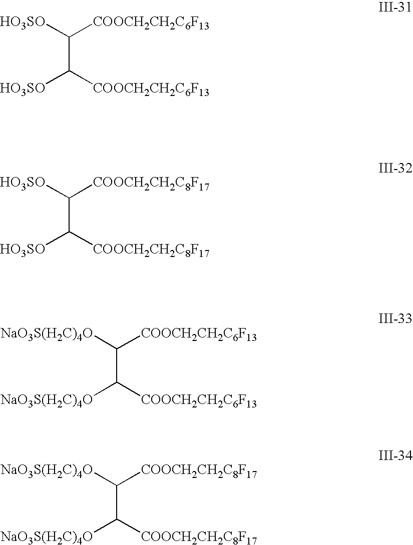

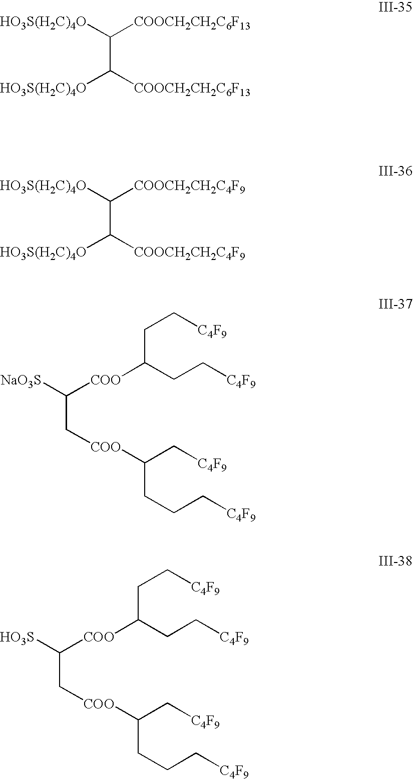

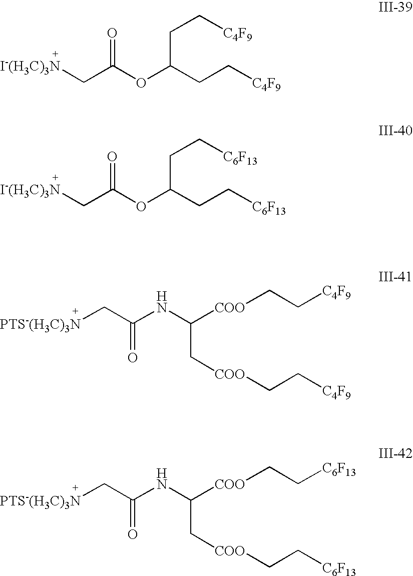

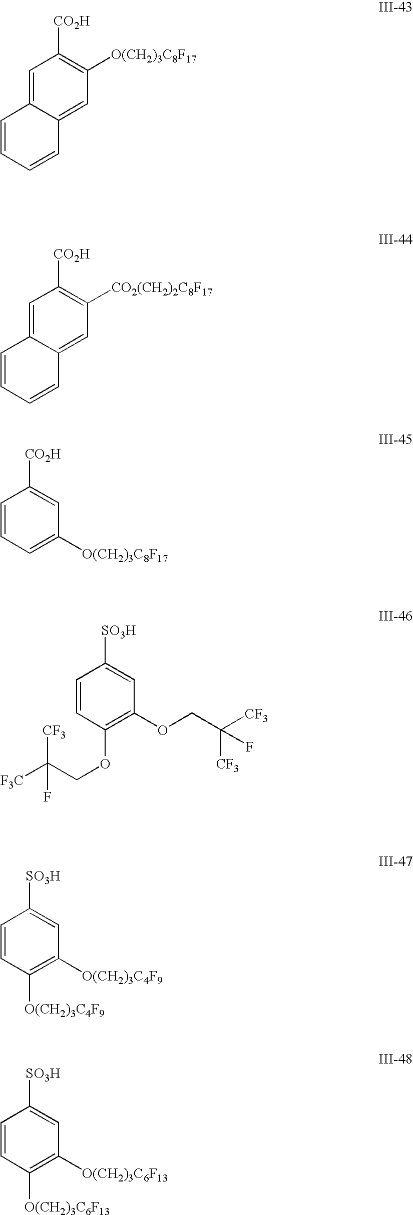

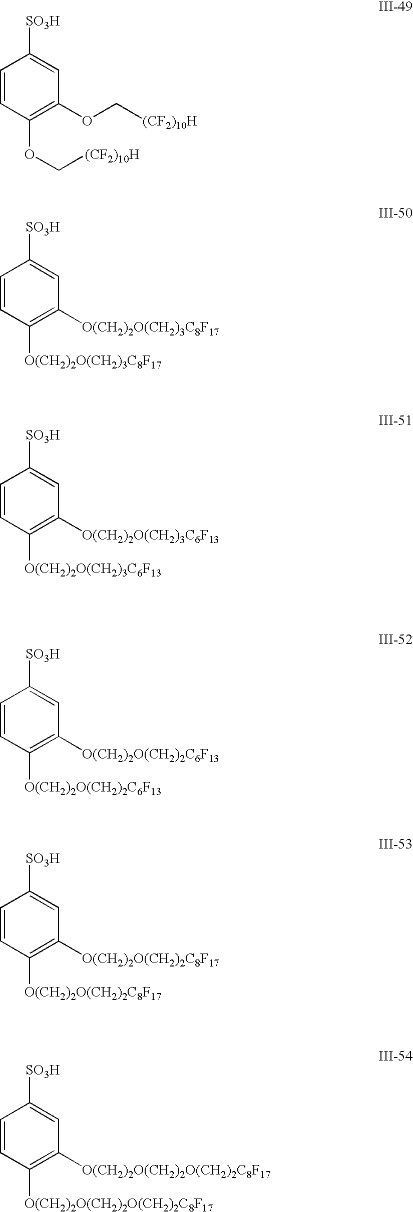

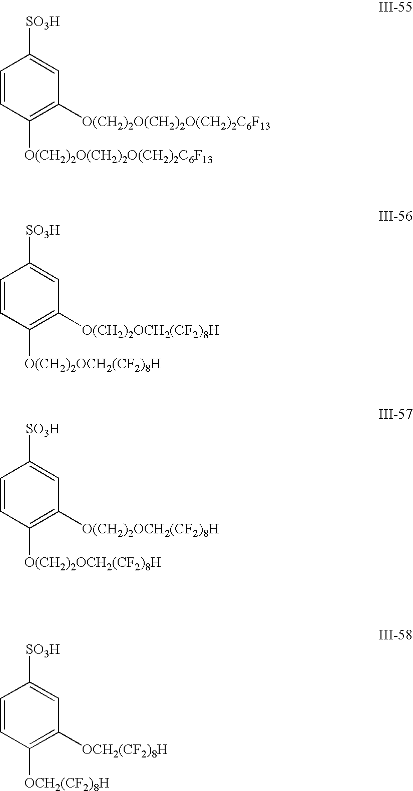

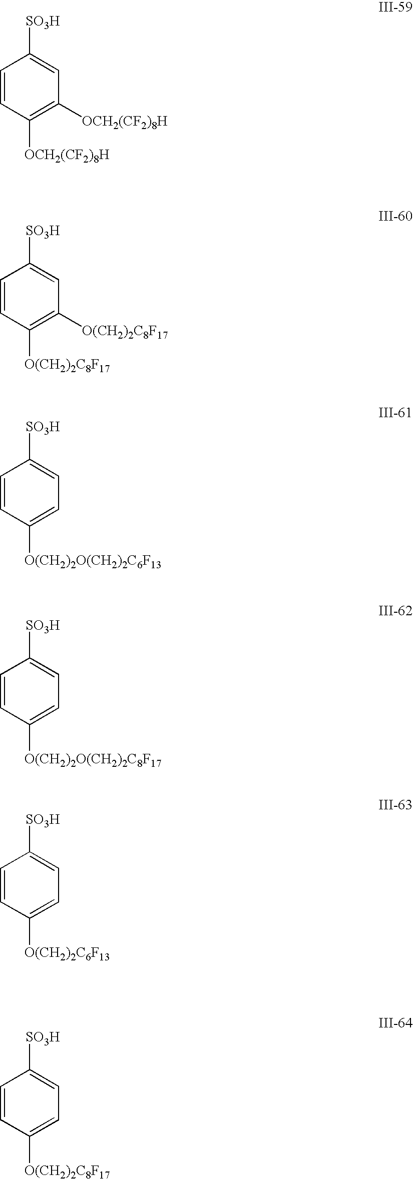

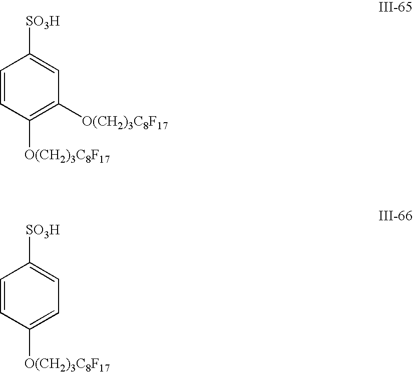

A preferable range of the content of the fluorine-containing polymer within the liquid crystalline composition (liquid crystalline composition without a solvent in the case of preparing as a coating solution) varies depending on their use, but it is preferably 0.005 to 8% by weight, more preferably 0.01 to 5% by weight, and even more preferably 0.05 to 1% by weight in the liquid crystalline composition.

[Coating Solvent]

For the solvent used to prepare a coating solution, an organic solvent can be preferably used. Examples of the organic solvent include amides (e.g., N,N-dimethylformamide), sulfoxides (e.g., dimethylsulfoxide), heterocyclic compounds (e.g., pyridine), hydrocarbons (e.g., benzene and hexane), alkyl halides (e.g., chloroform and dichloromethane), esters (e.g., methyl acetate and butyl acetate), ketones (e.g., acetone and methylethyl ketone), ethers (e.g., tetrahydrofuran and 1,2-dimethoxyethane). Alkyl halides and ketones are preferred. Two or more organic solvents may be used in combination. Coating of a coating solution can be performed by a known method (e.g., an extrusion coating method, a direct gravure coating method, a reverse gravure coating method, a dye coating method, etc.).

[Polymerization Initiator]

The vertically aligned liquid crystalline compound is fixed while maintaining the alignment state. Fixation is preferably carried out by polymerizing a polymerizable group (P) which was introduced to the liquid crystalline compound. Polymerization reaction includes thermopolymerization reaction using a thermopolymerization initiator and photopolymerization reaction using a photopolymerization initiator. Photopolymerization reaction is preferred. Examples of the photopolymerization initiator include α-carbonyl compounds (U.S. Pat. Nos. 2,367,661 and 2,367,670), acyloin ethers (U.S. Pat. No. 2,448,828), α-hydrocarbon substituted aromatic acyloin compounds (U.S. Pat. No. 2,722,512), polynuclear quinone compounds (U.S. Pat. Nos. 3,046,127 and 2,951,758), combination of triarylimidazole dimer and p-aminophenyl ketone (U.S. Pat. No. 3,549,367), acridine and phenazine compounds (JP-A No. 60-105667 and U.S. Pat. No. 4,239,850) and oxadiazole compounds (U.S. Pat. No. 4,212,970).

The content of the photopolymerization initiator is preferably 0.01 to 20% by weight, and more preferably 0.5 to 5% by weight of a solid matter in a coating solution. For the light irradiation for polymerization of a discotic liquid crystalline compound, UV ray is preferably used. The irradiation energy is preferably 20 mJ/cm² to 50 mJ/cm², and more preferably 100 mJ/cm² to 800 mJ/cm². In order to promote the polymerization reaction, light irradiation may be carried out under heating condition. The thickness of the retardation layer is preferably 0.1 to 10 μm, more preferably 0.5 to 5 μm, and most preferably 1 to 5 μm.

[Other Additives in Optically Anisotropic Layer]

In addition to the above-mentioned liquid crystalline compound, a plasticizer, a surfactant, polymerizable monomers or the like are used in combination, thereby allowing improvement in the uniformity of coating film, the film strength, alignment characteristics of liquid crystalline compound. For the materials, one having compatibility with a liquid crystalline compound and one not hindering the alignment is preferred.

For the polymerizable monomer, a radical polymerizable or cationic polymerizable compound may be mentioned. Preferably, a multifunctional radical polymerizable monomer which is copolymerizable with the liquid crystalline compound having a polymerizable group is preferred. Examples thereof include one described in the paragraph Nos. [0018] to [0020] of JP-A No. 2002-296423. The content of the compound with respect to the discotic liquid crystalline compound is preferably 1 to 50% by weight, and more preferably 5 to 30% by weight.

For the surfactant, a conventional compound may be mentioned, but particularly a fluorine-containing compound is preferred. Specific examples thereof include the compounds as described in the paragraph Nos. [0028] to of JP-A No. 2001-330725 and a compound as described in the paragraph Nos. [0069] to [0126] of JP-A No. 2003-295212.

A polymer used with a liquid crystalline compound, is preferably one which can increase viscosity of a coating solution. For the polymer, cellulose ester may be mentioned. Preferable examples of cellulose ester include one as described in the paragraph No. [0178] of JP-A No. 2000-155216. To prevent hindering of the alignment of liquid crystalline compound, the content of the polymer with respect to the liquid crystalline compound is preferably in the range of 0.1 to 10% by weight, and more preferably in the range of 0.1 to 8% by weight.

The transition temperature of discotic nematic liquid crystal phase-solid phase of the liquid crystalline compound is preferably 70 to 300° C., and more preferably 70 to 170° C.

[Alignment Layer]

In the invention, it is preferable that the liquid crystalline compound is coated on the surface of an alignment layer, thereby aligning the molecules of the liquid crystalline compound. The alignment layer is preferably used for carrying out the embodiment of the invention due to having a function of regulating the alignment direction of the discotic liquid crystalline compound. However, since the alignment layer completes its role once the alignment state is fixed after aligning the liquid crystalline compound, it is not an essential matter as a constitutional element of the invention. That is, it is possible to produce a polarizing plate by transferring only the optically anisotropic layer of the alignment layer where the alignment is fixed onto a polarizer.

An alignment layer can be prepared by means of the rubbing treatment of an organic compound (preferably a polymer), the oblique evaporation of an inorganic compound, formation of a layer having microgrooves, or accumulation of organic compounds (e.g., (ω-tricosanic acid, dioctadecylmethylammonium chloride and methyl stearate) by Langmuir-Blodgett method (LB film). Further, an alignment layer that exhibits an alignment function by a given electric field, a given magnetic field or light irradiation, is also known.

An alignment layer formed by the rubbing treatment of a polymer is preferred.

Examples of the polymer include methacrylate copolymers disclosed in the paragraph No. [0022] of JP-A No. 8-338913, styrene copolymers, polyolefins, polyvinyl alcohols and modified polyvinyl alcohols, poly(N-methylolacrylamides), polyesters, polyimides, vinyl acetate copolymers, carboxymethylcellulose, polycarbonates and the like. A silane coupling agent can be used as a polymer. Water-soluble monomers (e.g., poly(N-methylolacrylamides), carboxymethylcellulose, polyvinyl alcohols and modified polyvinyl alcohols) are preferred, gelatin, polyvinyl alcohols and modified polyvinyl alcohols are more preferred, and polyvinyl alcohols and modified polyvinyl alcohols are most preferred.

The saponification degree of polyvinyl alcohol is preferably 70 to 100%, and more preferably 80 to 100%. The polymerization degree of polyvinyl alcohol is preferably 100 to 5000.

In the alignment layer of the invention, it is preferable to bond the side chain having a crosslinkable functional group (e.g., a double bond) to the main chain or to introduce a crosslinkable functional group having a function of aligning the liquid crystalline compound to the side chain. For the polymer used in the alignment layer, a polymer which is possible of crosslinking by itself or which is crosslinked by use of a crosslinking agent can be used, and a plurality of their combination can be used.

When the side chain having a crosslinkable functional group is bonded to the main chain of the polymer for an alignment layer, or when a crosslinkable functional group is introduced to the side chain having a function of aligning the liquid crystalline compound, the polymer for an alignment layer can be copolymerized with a multifunctional monomer contained in the optically anisotropic layer. As a result, not only between a multifunctional monomer and a multifunctional monomer, but also between a polymer for the alignment layer and a polymer for the alignment layer, and also between a multifunctional monomer and a polymer for the alignment layer may form a strong bonding by copolymerization. Therefore, the strength of an optical compensation sheet can be improved significantly by introducing a crosslinkable functional group to the polymer for an alignment layer.

It is preferable for the crosslinkable functional group of a polymer for an alignment layer to contain a polymerizable group in the same manner as the multifunctional monomer. Specific examples thereof include one as described in the paragraph Nos. [0080] to [0100] of JP-A No. 2000-155216.

The polymer for an alignment layer can be crosslinked using a crosslinking agent apart from the crosslinkable functional group. Examples of the crosslinking agent include aldehydes, N-methylol compounds, dioxane derivatives, compounds produced by activating a carboxyl group, an activated vinyl compound, an activated halogen compound, isooxazole and dialdehyde starch. Two or more crosslinking agents may be used in combination. Specific examples thereof include the compounds or the like described in the paragraph Nos. [0023] to [0024] of JP-A No. 2002-62426. Aldehydes with high reaction activity are preferred, and glutaraldehyde is more preferred.

The content of the crosslinking agent with respect to a polymer is preferably 0.1 to 20% by weight, and more preferably 0.5 to 15% by weight. The amount of remaining unreacted crosslinking agent in the alignment layer is preferably 1.0% by weight or less, and more preferably 0.5% by weight or less. Once controlled as such, sufficient durability without generating reticulation can be obtained even when the alignment layer is used for a long time in the liquid crystal display device or when the alignment layer is left to stand under a high temperature and high humidity atmosphere for a long time.

An alignment layer can be formed, for example, by coating a solution containing the polymer, which is an alignment layer forming material, a crosslinking agent and an additive onto a transparent support, and then heat drying (crosslinking) and subjecting to the rubbing treatment. The crosslinking reaction may be performed at an arbitrary period after coating a solution onto a transparent support as mentioned above. When a water-soluble polymer such as polyvinyl alcohol is used as an alignment layer forming material, it is preferable to use a coating solution in a mixed solvent of water and an organic solvent (e.g., methanol) having defoaming action. Their proportions in the weight ratio of water:methanol is preferably 0:100 to 99:1, and more preferably 0:100 to 91:9. In this regard, foam generation is inhibited so that defects in the alignment layer and the surface of the optically anisotropic layer are significantly reduced.

A method for coating an alignment layer is preferably a spin coating method, a dip coating method, a curtain coating method, an extrusion coating method, a rod coating method or a roll coating method, and more preferably a rod coating method. Further, the film thickness after drying is preferably 0.1 to 10 μm. Heat drying can be performed at 20° C. to 130° C. In order to form sufficient crosslinking, the heat drying is performed preferably at 40° C. to 120° C., and more preferably at 50° C. to 110° C. Time for performing drying can be 1 minute to 36 hours, and preferably 1 minute to 30 minutes. pH is set preferably at a value which is most suitable for the used crosslinking agent and when using a glutaraldehyde, pH is set preferably at 4.5 to 5.5, and more preferably at 5.

The alignment layer is preferably provided on a transparent support. The alignment layer can be obtained by crosslinking the polymer layer as mentioned above, and than subjecting the surface to the rubbing treatment.

For such the rubbing treatment, a treatment method which is widely applied as a process for treating the alignment for liquid crystal of LCD, can be applied. That is, a method of achieving the alignment by rubbing the surface of the alignment layer using paper or gauze, felt, rubber or nylon, polyester fibers or the like, can be used. In general, the method is carried out by performing rubbing about a number of times using a cloth which has averagely transplanted fibers having a uniform length and thickness.

To the rubbing treated alignment layer surface, the liquid crystalline composition is coated and the molecules of the discotic liquid crystalline compound are aligned. Thereafter, if necessary, the polymer for an alignment layer is reacted with a multifunctional monomer contained in an optically anisotropic layer, or the polymer for an alignment layer is crosslinked using a crosslinking agent, thereby forming the optically anisotropic layer.

The thickness of the alignment layer is preferably in the range of 0.1 to 10 μm.

[Support]

The retardation plate of the invention may comprise a support. The retardation plate having self supportability can be produced by forming an optically anisotropic layer by coating a liquid crystalline composition onto a support. Only one layer of an optically anisotropic layer may be formed on the support, two or more layers of an optically anisotropic layer may be laminated in orderly on one side of the surface of the support, and an optically anisotropic layer may be formed on both surfaces of the support.

For the support, a polymer film having low wavelength dispersion is preferably used. The support having low optical anisotropy is more preferred. The support having a light transmittance of 80% or more (a transparent support) is preferred. For low wavelength dispersion, specifically, the ratio of Re₄₀₀/Re₇₀₀ of less than 1.2 is preferred.

The optical compensation film may use a support having optical anisotropy to regulate to satisfy each optical property. The support used in the optical compensation film of the invention has preferably Re of 0 to 20 nm and Rth of −100 nm to 100 nm, and more preferably Re of 0 to 10 nm and Rth of −100 nm to 20 nm.

Examples of the polymer include cellulose esters, polycarbonates, polysulfones, polyeter sulfones, polyacrylates, polymethacrylates and cyclic polyolefins. Among these, cellulose esters are preferred, and cellulose acylates are more preferred. Examples of the cyclic polyolefin, a polymer having the polymers obtained by hydrogenating an open-ring polymer of tetracyclododecenes or open-ring copolymers of tetracyclododecenes and norbornenes as a constitutional component as described in JP-B No. 2-9619, ARTON (trade name, manufactured by JSR Corp.), series of ZEONEX and ZEONOR (trade names, manufactured by Zeon Corp. in Japan), can be used. The polymer film is preferably formed by a solution casting method.

The polymer film is preferably formed by a solution casting method. The thickness of a transparent support is preferably 20 to 500 μm, and more preferably 50 to 200 μm. In order to improve adhesiveness between the support and a layer provided thereon (an adhesive layer, a vertical alignment layer or a retardation layer), the surface treatment (e.g., a glow discharge treatment, a corona discharge treatment, an ultraviolet (UV) radiation treatment, a flame treatment) may be performed on the support. On the support, an adhesive layer (under coat layer) may be provided. In addition, in order to give slidability in the conveying process or to prevent adhesion of the surface with the reverse surface after rolling, it is preferable to use a support or a long support which is formed by coating one side of the support or co-casting with the support of a polymer layer, in which the inorganic particles having an average particle size of 10 to 100 nm are mixed at a weight ratio of the solid content of 5% to 40%.

A preferable embodiment of the invention is that the slow axis of the optically anisotropic layer is neither parallel nor perpendicular to the longitudinal direction of the support. In particular, the angle formed by the longitudinal direction of the support and the slow axis of the optically anisotropic layer is preferably 5 to 85°. The angle of the slow axis of the optically anisotropic layer can be controlled by the angle of rubbing. By having the slow axis of the optically anisotropic layer in neither parallel or perpendicular to the longitudinal direction of the long support (e.g., by forming an alignment layer on the support and subjecting the alignment layer to rubbing treatment at 5 to 85° direction to the longitudinal direction of the film), in producing an elliptic polarizing plate, it is possible to adhere with a long polarizing film by roll-to-roll, which makes it possible to produce an elliptic polarizing plate with high precision of axis angle, and high productivity.

[Polymer Film Comprising Optical Compensation Film]

The optical compensation film used in the invention may be formed from the birefringence polymer film. The optical compensation film made of the birefringence polymer film may or may not further include an optically anisotropic layer containing a liquid crystalline compound. The polymer film is formed from a polymer that can exhibit birefringence property. For the birefringence polymer film, one having controllability of birefringence property, transparency, excellent heat resistance and small photoelasticity is preferred. In this case, a material for polymer is not particularly limited, as long as the polymer can achieve the uniaxial alignment or biaxial alignment, but a polymer capable of producing film by a solution casting method or an extrusion molding method is preferably used. Examples thereof include aromatic polymers such as norbornene polymers, polycarbonate polymers, polyarylate polymers, polyester polymers, polysulfones, polyolefins such as polypropylenes, cellulose acylates or a combination of two kinds, or three or more kinds of the polymers.

Any optical property of an optical compensation film can be exhibited by selecting a polymer material or a stretching method.

The optical anisotropy of a polymer film can be preferably obtained by a uniaxial or biaxial stretching. For the uniaxial stretching, a vertical uniaxial stretching using the peripheral speed difference of two or more rolls or tenter stretching which stretches both sides of a polymer film in the width direction is preferred. In addition, optical anisotropy of the optically biaxial may be exhibited by stretching a polymer film in the vertical and horizontal directions. In addition, using two sheets or more polymer films, the whole optical properties of the two or more films may satisfy the above-mentioned condition. The polymer film is preferably produced by a solution casting method to reduce unevenness of the birefringence. The thickness of the polymer film is preferably 20 to 400 nm, and most preferably 30 to 100 nm.

A polymer film having optical properties to have a negative value of Rth is easily formed by a method stretching in the thickness direction of a film by adhering heat shrinkable film with the polymer film and increasing a predetermined tension while heating (JP-A Nos. 2000-206328 and 2000-304925), or by a method of coating vinyl carbazole polymers on the polymer film and drying (JP-A No. 2001-091746).

[Polarizing Plate]

The liquid crystal display device of the invention include the above-mentioned optical compensation film (1) and the polarizing film. The optical compensation film (1) which will be integrated as a protective film of a polarizing film, is preferred. Further, the optical compensation film (1) may be adhered with a polarizing plate having a protective film.

The polarizing films include an iodine-based polarizing film, a dye-based polarizing film which uses a dichromatic dye and a polyene-based polarizing film. In general, polyvinyl alcohol-based films are used to produce iodine-based polarizing films and dye-based polarizing films. The absorption axis of the polarizing film is equivalent to the stretching direction of the film. Therefore, the polarizing film stretched to the vertical direction (conveying direction) has the absorption axis parallel to the longitudinal direction, and the polarizing film stretched to the cross direction (conveying direction and perpendicular direction) has the absorption axis perpendicular to the longitudinal direction.

Preferable methods for production of polarizing plate of the invention include a process of continuously laminating the respective polarizing film and retardation plate longitudinally. Moreover, the long polarizing plate is cut to fit the size of a screen in the liquid crystal display device.

If a linearly polarizing film and a retardation plate are combined to be composed as an elliptic polarizing plate, it can be easily incorporated in the reflective type and semi-transmission type liquid crystal display device. Further, it can be used as an antireflection film of an organic EL display unit. In addition, because the separately prepared long cholesteric liquid crystalline film may be further laminated on the elliptic polarizing plate, a brightness improving film having high productivity is thus produced easily.

The polarizing film usually contains a protective film. According to the invention, when an optically anisotropic layer comprising liquid crystalline compounds is formed on a support, the transparent support may function as a protective film. When the protective film of the polarizing film is used separately from the support, it is preferable that a cellulose ester film or a norbornene-based polymer film that has high optically isotropic characteristics as a protective film is used.

[Liquid Crystal Display Device]

The liquid crystal display device of the invention has at least the optical compensation film (1), which includes a reflective type, semi-transmission type and transmission type liquid crystal display devices. Liquid crystal display device is generally composed of a polarizing plate, a liquid crystal cell, and if necessary, a retardation plate, a reflective layer, a light diffusion layer, a backlight, a front light, a light control film, a light guiding plate, a prism sheet, a color filter or the like as a member. In the invention is not particularly limit, except for an essential point that the optical compensation film (1) is provided between a source of light and a polarizing film nearest to the source of light. Moreover, the optical compensation film may be provided in one place or multiple places. The liquid crystal cell is not particular limited, but a typical liquid crystal cell in which a pair of transparent substrate comprising electrodes to be maintained in narrow is used. The transparent substrate comprising a liquid crystal cell not particularly limited as long as the crystalline materials composing the liquid crystal cell are aligned in a specific alignment direction. Particularly, any one of a transparent substrate that has the property to align the liquid crystal by itself, or a transparent substrate that lacks the property to align the liquid crystal by itself, but contains an alignment layer or the like having the property to align liquid crystal is used. Moreover, for the electrodes in the liquid crystal cell, a well-known electrode can be used. In general, the electrodes can be provided on the surface of the transparent substrate contacting the liquid crystal layer, thus in the case of using a substrate having an alignment layer, the electrodes can be provided between the substrate and the alignment layer. The liquid crystalline materials for forming the liquid crystal layer is not particularly limited, but mention may be made of a typical low-molecular weight liquid crystalline compound, a high-molecular weight liquid crystalline compound, and a mixture thereof. In addition, a pigment or a chiral agent, a non-liquid crystalline compound, or the like can be added to the extent of not impairing the liquid crystallinity.

The liquid crystal cell may include, in addition to the electrode substrate and a liquid crystal layer, various constitutional elements used for various mode for liquid crystal cells to be described below. Examples of various modes include a TN (Twisted Nematic) mode, an STN (Super Twisted Nematic) mode, an ECB (Electrically Controlled Birefringence) mode, an IPS (In-Plane Switching) mode, a VA (Vertical Alignment) mode, an MVA (Multidomain Vertical Alignment) mode, a PVA (Patterned Vertical Alignment) mode, an OCB (Optically Compensated Birefringence) mode, a HAN (Hybrid Aligned Nematic) mode, an ASM (Axially Symmetric Aligned Microcell) mode, a half tone gray scale mode, a domain division mode or a display mode using a ferroelectric liquid crystal and an anti-ferroelectric liquid crystal. In addition, the driving mode of the liquid crystal cell is not particularly limited, but any driving mode such as a passive matrix mode used in STN-LCD or the like, and an active matrix mode using active electrodes such as a TFT (Thin Film Transistor) electrode, a TFD (Thin Film Diode) electrode or the like are used. The driving mode may be a field sequential mode which does not use a color filter.

The liquid crystal display of the invention is provided with a source of light, an optical compensation film (1) (preferably an optical compensation film (2)), a polarizing film, and a liquid crystal cell in this order. Between the source of light and the optical compensation film (1), a brightness improving film exemplified as follows is preferably further provided.

[Linear Polarization Split Type Brightness Improving Film]

A linear polarization split type brightness improving film is a light-scattering polarizing element or a light-reflecting polarizing element, which scatters or reflects the linearly polarized light having predetermined polarizing axis and transmits another light component, when the natural light is emitted by a backlight such as a liquid crystal display device or reflected from rear side.

The polarizing plate in which the light-scattering or light-reflecting polarizing element is laminated on the light-absorbing polarizing element, obtains the transmitting light having a predetermined polarized state from the light emitted from light sources such as a backlight, and reflects the light other than the predetermined polarized state. The reflected light by the brightness improving film is converted through the reflection layer provided on a rear side, introduced back to the brightness improving film and transmitted as the predetermined polarized light, so that quantity of the light transmitting the brightness improving film is increased and polarized light, which is difficult to be absorbed by polarizer is supplied. Accordingly, the amount of usable light for liquid crystal image display is increased and the brightness is improved. If the brightness improving film is used, when the light is entered through the polarizer from the rear side of liquid crystal cell in backlight, most of the light having the polarized direction not consistent with polarizing axis of polarizer is absorbed by the polarizer and not transmitted through the polarizer. Depending on the property of the polarizer, almost 50% of light is absorbed by the polarizer, and thus the light quantity for the liquid crystal display is decreased so that the image becomes a dark image. The brightness improving film reflects the light incident in a polarization direction so as to be absorbed by the polarizer, not to introduce to the polarizer, converts by the reflection layer deposed on rear side to re-enter to the brightness improving film and repeats the reflection and reentering in this way. As a result, the brightness improving film passes only the polarized light having polarizing direction which can be transmitted by the polarizer, and supplies to the polarizer. Hence, the light such as backlight is efficiently used for the liquid crystal display to brighten the image.

The following mechanisms (A) to (D) have been proposed to improve the efficiency of light by the use of linear polarization split type brightness improving film (light-scattering or light-reflecting polarizing element). Any of these mechanisms can be desirably applied to the liquid crystal display device of the invention.

(A) Depolarization of Front Scattered Light

The light-scattering polarizing element scatters the polarized light component perpendicular to the polarizing axis forward or backward. The front light scattered is depolarized. The polarizing direction of front scattered light rotates in the polarizing direction of incident light, hence the component polarized in the polarizing direction of the light-scattering polarizing element is increased. If the polarizer contains many particles in the thickness direction, multiple scattering occurs to enhance the depolarization. In this way, the efficiency of light is improved by the depolarization of front scattered light if the light-scattering polarizing plate is used, as compared with the efficiency when the light-absorbing polarizing plate is used alone.

(B) Reuse (Depolarization) of Rear Scattered Light

The rear scattered light of polarized component perpendicular to the polarizing axis of light-scattering polarizing element is depolarized when it is scattered backward. The back scattered light is reflected by a metal reflector placed behind the backlight which is a light source, and again enter the light-scattering polarizing element. Since the reentered light is depolarized when back scattered, polarized component parallel to the polarizing axis of light-scattering polarizing plate is generated and these polarized components pass through the scattering polarizer. In this way, backward scattering by light-scattering polarizing element and reflection by the metal reflector are repeated to improve the efficiency of light.

(C) Reuse (Rotation of Polarizing Direction) of Back Scattered Light

In an optical system comprising λ/4 plate and a metal reflector, incident light linearly polarized at 45° to the slow axis of the λ/4 plate is reflected to rotate its polarizing direction by 90°. For achieving this effect, a λ/4 plate is provided between the light-scattering polarizing element and the metal reflector (placed behind the backlight) so that the slow axis of the λ/4 plate may be placed at 45° to the polarizing axis of the light-scattering polarizing element.

In distribution of polarizing direction of back scattered light of the light scattered polarizer, the direction of the scattering polarizing element polarized perpendicular to the polarizing axis is large. The light scattered backward, passed through the λ/4 plate, reflected by the metal reflector and then reentered to the polarizer has a light component polarized parallel to the polarizing axis of the polarizer in a large amount, thus the light component parallel polarized can pass through the polarizer. Accordingly, the efficiency of light is improved by the λ/4 plate provided between the light-scattering polarizing element and the metal reflector.

(D) Reuse of Linearly Polarized Reflection Light

The light-reflecting polarizing element which absorb the polarized light having predetermined direction, while reflect the polarized light having the other direction has been proposed. The reflected scattering light can be reused. There is a commercially available light-reflecting polarizing element. For example, the light-reflecting polarizing element with function that linearly polarized light of predetermined direction is passed through, while the other light is reflected such as multi-layered thin film of dielectric and multi-layered (specifically, hundreds of the layers) body of thin film with different reflective anisotropy, is commercially available (for example, D-BEF manufactured by 3M Corporation). This light-reflecting polarizing element has reflective index difference between the polymers in some direction, and the incident light is reflected therefrom. On the other hand, the incident polarized light not having reflective index difference between the polymers is transmitted through.

[Circular Polarized Separating Brightness Improving Film]

The circularly polarized separating brightness improving film is also used behind usual liquid crystal cell. The circularly polarized separating brightness improving film has a function that if the natural light is introduced by reflection from backlight of liquid crystal display or rear side, the polarized light of predetermined direction is reflected, while the other light is passed through. The polarizing plate, which laminated the light-absorbing polarizing element and the light-scattering or light-reflecting polarizing element, obtains the transmitting light having predetermined polarized state from the light emitted from light sources such as backlight, and reflects the light other than the predetermined polarized state. The reflected light by the brightness improving film is converted by the reflection layer provided on a rear side, introduced back to the brightness improving film and transmitted as the predetermined polarized light, so that quantity of the light transmitting the brightness improving film is increased and polarized light, which is difficult to be absorbed by polarizer is supplied. Accordingly, the amount of usable light for liquid crystal image display is increased and the brightness is improved. If the brightness improving film is used, when the light is entered through the polarizer from the rear side of liquid crystal cell in backlight, most of the light having the polarized direction not consistent with polarizing axis of polarizer is absorbed by the polarizer and not transmitted through the polarizer. Depending on the property of the polarizer, almost 50% of light is absorbed by the polarizer, thus the light quantity for the liquid crystal display is decreased to darken the image. The brightness improving film reflects the incident light having polarization direction which absorbed by the polarizer, not to introduce to the polarizer, converts by the reflection layer deposed rear side to reenter to the brightness improving film and repeats the reflection and reentering in this way. As a result, the brightness improving film is passed through only the polarized light having the polarizing direction which can be transmitted by a polarizer, and is supplied to the polarizer. Hence the light such as back light is efficiently used for liquid crystal display to brighten the image.

In the circular polarization scattering film, the circularly polarized light is emitted by a cholesteric liquid crystal layer, converted to linearly polarized light by a λ/4 wavelength plate to constrain the absorption loss and entered into the light-absorbing polarizing element.

The retardation plate, which serves as a λ/4 wavelength plate in the broad wavelength range such as visible light zone can be obtained by laminating the retardation plate. Thus, the retardation plate provided between the polarizing plate and the brightness improving film may be produced by one layer or two or more layer of the retardation plate.

Moreover, two, or three or more cholesteric liquid layers having a difference reflection wavelength are laminated to reflect the circularly polarized light in the broad wavelength range, hence transmitting circularly polarizing plated with broad wavelength range is obtained.

### EXAMPLES

Hereinafter, the present invention will be further described in detail with reference to Examples and Comparative Examples. Materials, contents, ratios, processing contents, processing order and the like as presented below may be suitably modified as long as the object of the invention is not impaired. However, the scope of the invention is not limited to these specific examples below.

### Example 1

### Production of cellulose acetate film

(Preparation of Cellulose Acetate Solution)

The following composition was fed into a mixing tank and agitated to dissolve individual components, thereby preparing a cellulose acetate solution A.

Composition of cellulose acetate solution A

| | |
|---|---|
| Cellulose acetate with degree of substitution of 2.94 | 100 parts by weight |
| Methylene chloride (first solvent) | 402 parts by weight |
| Methanol (second solvent) | 60 parts by weight |

(Preparation of Solution of Matting Agent)

20 parts by weight of silicon dioxide particles with an average particle size of 16 nm (AEROSIL R972, manufactured by Nippon Aerosil Co., Ltd.) and 80 parts by weight of methanol were stirred and mixed well for 30 minutes to give a dispersion of silicon dioxide particles. This dispersion together with the following compositions were fed to a disperser and further agitated for at least 30 minutes to dissolve individual components, thereby preparing a solution of matting agent.

Composition of solution of matting agent

| | |
|---|---|
| Dispersion of silicon dioxide particles with average | 10.0 parts by weight |
| particle size of 16 nm | |
| Methylene chloride (first solvent) | 76.3 parts by weight |
| Methanol (second solvent) | 3.4 parts by weight |
| Cellulose acetate solution A | 10.3 parts by weight |

(Preparation of Solution of Additive)

The following compositions were fed into a mixing tank and agitated under heating to dissolve individual components, thereby preparing a cellulose acetate solution.

Composition of additive solution

| | | |
|---|---|---|
| Compound for reducing optical | 49.3 | parts by weight |
| anisotropy | | |
| Wavelength dispersion regulating agent | 4.9 | parts by weight |
| Methylene chloride (first solvent) | 58.4 | parts by weight |
| Methanol (second solvent) | 8.7 | parts by weight |
| Cellulose acetate solution A | 12.8 | parts by weight |

Optical anisotropy reducing agent

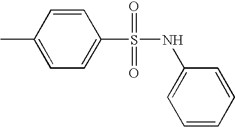

Wavelength dispersion regulating agent

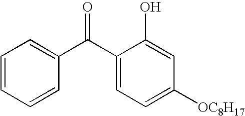

(Production of Cellulose Acetate Film)

94.6 parts by weight of the above-mentioned cellulose acetate solution A, 1.3 parts by weight of a solution of matting agent and 4.1 parts by weight of an additive solution were each independently filtered and then mixed. The mixture was cast using a band casting machine. The weight ratio of the compound for reducing optical anisotropy and the wavelength dispersion regulating agent to cellulose acetate in the above-mentioned composition were 12% and 1.2%, respectively. Film was peeled off from the band with the remaining solvent content of 30% and dried at 140° C. for 40 minutes to give a cellulose acetate film of 80 μm in thickness.

The optical properties of the obtained film were measured with the use of an automatic birefringence meter (KOBRA-21ADH, manufactured by Oji Scientific Instruments). At 589 nm, the in-plane retardation (Re) was 1 nm (the slow axis is in the perpendicular direction to the longitudinal direction of a film) and the retardation (Rth) in the thickness direction was −1 nm.

<Production of Optical Compensation Film (1)-A>

(Formation of Alignment Layer)

The surface of cellulose acetate film produced in the above was saponified, and then a coating solution for alignment layer in the following composition was continuously applied thereon using a wire bar coater of #14. The coating was dried for 60 seconds with a warm air of 60° C. and for 120 seconds with a warm air of 100° C. to form an alignment layer.

Composition of coating solution for alignment layer

| | | |
|---|---|---|
| modified polyvinyl alcohol shown below | 10 | parts by weight |
| water | 371 | parts by weight |
| methanol | 119 | parts by weight |
| glutaraldehyde | 0.5 | part by weight |

Modified polyvinyl alcohol

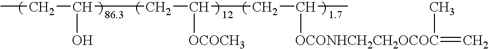

(Production of Optically Anisotropic Layer Containing Liquid Crystalline Compound)

To the surface of the alignment layer produced in the above, a coating solution containing a rod-shaped liquid crystalline compound in the following composition was continuously applied with use of #5.0 wire bar coater. The coating layer was heated at 90° C. for 60 seconds for drying the solvent in the coating solution and for alignment aging of the rod-shaped liquid crystalline compound. Subsequently, the alignment of the liquid crystalline compound was fixed by irradiation of UV, thereby formed an optically anisotropic layer. Thereafter, the surface of the cellulose acetate film on the opposite side of the surface formed of the optically anisotropic layer was continuously subjected to saponification treatment to produce an optical compensation film (1)-A.

Composition of coating solution containing
rod-shaped liquid crystalline compound

| | | |
|---|---|---|
| rod-shaped liquid crystalline compound shown | 100 | parts by weight |
| below | | |
| photopolymerization initiator | 3 | parts by weight |
| (IRGACURE 907, manufactured by | | |
| Ciba-Geigy AG) | | |
| sensitizer (KAYACURE DETX, manufactured | 1 | part by weight |
| by Nippon Kayaku Co., Ltd.) | | |
| fluorine-containing polymer P-22 | 0.2 | part by weight |
| fluorine-containing polymer D shown below | 0.2 | part by weight |
| pyridinium salt I-12 | 2 | parts by weight |
| methanol | 30 | parts by weight |
| methylethyl ketone | 168 | parts by weight |

rod-shaped liquid crystalline compound

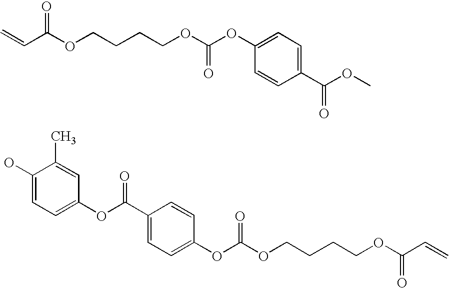

fluorine-containing polymer (D)

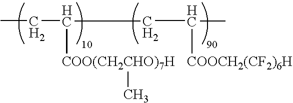

Re and Rth of the optical compensation film (1)-A at 589 nm were 0 nm and −306 nm, respectively. In addition, it was confirmed that the rod-shaped liquid crystalline compound was formed of an optically anisotropic layer in the perpendicular alignment to the film plane.

<Production of Optical Compensation Film (2)-A>

A roll-shaped norbornene-based polymer film (ARTON, manufactured by JSR Corp.) of 100 μm in thickness was vertically uniaxial stretched continuously in the conveying direction at the temperature of 180° C. to obtain an ARTON film of 500 m in length. The optical characteristics of the ARTON film were measured, and as a result, Re was 126 nm and Rth was 63 nm, and the optic axis was parallel to the plane of the film. In addition, the slow axis direction of the ARTON film was parallel to the longitudinal direction of the roll film. This film was assumed to be the optical compensation film (2)-A.

### Example 2

### Production of Optical Compensation Film C Laminated with Optical Compensation Film (1)-B and Optical Compensation Film (2)-B

In the same manner as in Example 1, an optical compensation film (1)-B was produced, except that a coating solution including a rod-shaped liquid crystalline compound was coat as #3.0. Re and Rth of the optical compensation film (1)-B at 589 nm were 0 nm and −184 nm, respectively. On the optically anisotropic layer containing a rod-shaped liquid crystalline compound of the optical compensation film (1)-B, a coating solution for an alignment layer of the following composition was coated, and an alignment layer was formed. This alignment layer was subjected to the rubbing treatment continuously at the 45° to the longitudinal direction of the optical compensation film (1)-B.

To the surface of the alignment layer produced in the above, a coating solution containing a discotic liquid crystalline compound in the following composition was continuously applied with use of #3.6 wire bar coater to produce an optical compensation film (2)-B. The coating layer was heated at 100° C. for 30 seconds, and further heated at 130° C. for 60 seconds for drying the solvent in the coating solution and for alignment aging of the discotic liquid crystalline compound. Subsequently, the alignment of the liquid crystalline compound was fixed by irradiation of UV, thereby producing an optical compensation film C laminated with the optical compensation film (1)-B and the optical compensation film (2)-B. Re and Rth of the optical compensation film (2)-B at 589 nm were 122 nm and −61 nm, respectively. In addition, an average inclined angle to the film plane of the optical compensation film of a disc plane of a discotic liquid crystalline compound was 90°, and it was confirmed that the discotic liquid crystal was aligned perpendicular to the film plane of the optical compensation film.

Composition of coating solution containing a
discotic liquid crystalline compound

| | | |
|---|---|---|
| discotic liguid crystalline compound shown below | 91 | parts by weight |
| ethylene oxide-modified trimethylolpropane | 9 | parts by weight |
| triacrylate (V#360, manufactured by Osaka | | |
| organic chemistry Co., Ltd.) | | |
| photopolymerization initiator (IRGACURE 907, | 3 | parts by weight |
| manufactured by Ciba-Geigy AG) | | |
| sensitizers (KAYACURE DETX, manufactured | 1 | part by weight |
| by Nippon Kayaku Co., Ltd.) | | |
| fluorine-containing polymer P-19 | 0.4 | part by weight |
| pyridinium salt I-30 | 0.5 | part by weight |
| methanol | 30 | parts by weight |
| methylethyl ketones | 165 | parts by weight |

Discotic liquid crystalline compound

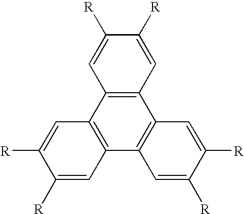

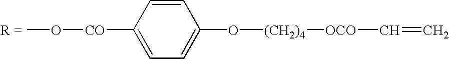

Re and Rth of the optical compensation film C at 589 nm were 122 nm and −245 nm, respectively. In addition, the direction of slow axis was parallel to the rubbing direction of an alignment layer, and the angle formed with the longitudinal direction of the support was 45°.

<Production of Polarizing Plate a with Brightness Improving Film>

A roll-shaped polyvinyl alcohol film of 80 m in thickness, which was continuously soaked in an aqueous iodine solution, was stretched to 5 times its original length in the conveying direction and dried to obtain a long polarizing film. To one side of the polarizing film, the surface of the above-obtained optical compensation film (1)-A not forming optical anisotropy was adhered, while to the other side, a viewing angle-widening film (Wide View SA, manufactured by Fuji Photo Film Co., Ltd.) was adhered continuously using a polyvinyl alcohol-based adhesive to produce a long polarizing film. The absorption axis of a polarizing film was parallel to the longitudinal direction of the film, and the slow axis of the wide view film was perpendicular to the longitudinal direction of the film. This polarizing plate and the optical compensation film (2)-A were cut respectively, and adhered using an adhesive such that the angle form by the absorption axis of a polarizing film and the slow axis of optical compensation film (2)-A became 45°, thereby forming an elliptic polarizing plate.

Subsequently, in the same manner as disclosed in Examples of JP-A No. 2003-337221, a long cholesteric liquid crystalline film was produced. The obtained cholesteric liquid crystalline film was cut and adhered with the elliptic polarizing plate using an adhesive. Here, the cholesteric liquid crystalline film was adhered on the optical compensation film (2)-A side. In this way, a polarizing plate A with a circularly polarized light-separating type brightness improving film was produced.

<Production of Polarizing Plate B with Brightness Improving Film>

In the same manner as the production of the polarizing plate, a long elliptic polarizing plate was produced by continuously adhering an optical compensation film C, a polarizing film and a viewing angle-widening film. An absorption axis of the polarizing film was parallel with the longitudinal direction of the optical compensation film C, and the slow axis of a wide view film was perpendicular to the longitudinal direction of the film. The angle formed by the absorption axis of the polarizing film and the slow axis of the optical compensation film C was 45.0°.

In the same manner, a long cholesteric liquid crystalline film was produced. The above-obtained elliptic polarizing plate and the cholesteric liquid crystalline film were continuously adhered in their respective lengthy state. At this time, the cholesteric liquid crystalline film was adhered such that it was on the optical compensation film C side. In this way, a polarizing plate B with a circularly polarized light-separating type brightness improving film was produced.

### Comparative Example

### Production of Polarizing Plate C with Brightness Improving Film

Polarizing plate C with a circularly polarized light-separating type brightness improving film was produced in the same manner as the production of polarizing plate A with brightness improving film, except that a commercially available cellulose acetate film (FUJITAC TD80UL, manufactured by Fuji Photo Film Co., Ltd.; thickness: 80 μm, Re=3 nm, and Rth=45 nm) was used instead of the optical compensation film (1)-A.

<Production of Liquid Crystal Display>

Among a pair of polarizing plate provided in liquid crystal display device using a TN type liquid crystal cell (AQUOS LC20C1S, manufactured by Sharp Corporation), only the polarizing plate in the backlight side was peeled off, and instead, the above obtained the brightness improving films A, B and C were adhered by introducing an adhesive such that a wide view film was on the liquid crystal cell side. The transmission axis of the polarizing plate in the observer side and the transmission axis of polarizing plate in the backlight side were provided to become an O mode.

With respect to the liquid crystal display device, the viewing angle was measure from black display (L1) to white display (L8) using a measuring machine (EZ-Contrast 160D, manufactured by ELDIM Co). For the front brightness at the time of white display, the case of using any one of the brightness improving film A and the brightness improving film B was 1.3 times the case of using the brightness improving film C. Further, when white display was observed from an inclined direction, the case of using the brightness improving films A and B had less coloring compared with the case of using the brightness improving film C.

1. A liquid crystal display device comprising a light source, a polarizing film and a liquid crystal cell in this order,
wherein a first optical compensation film having an in-plane retardation (Re) of to 20 nm and a retardation (Rth) in the thickness direction of −1000 to 20 nm is provided between the light source and the polarizing film.

2. The liquid crystal display according to claim 1,
wherein the first optical compensation film includes an optically anisotropic layer containing at least one kind of liquid crystalline compound.

3. The liquid crystal display device according to claim 2,
wherein the optically anisotropic layer included in the first optical compensation film contains a rod-shaped liquid crystalline compound, and the alignment state is fixed such that the longitudinal direction of the rod-shaped liquid crystalline compound is substantially perpendicular to the film plane of the first optical compensation film.

4. The liquid crystal display device according to claim 2,
wherein the first optical compensation film includes at least a support and the optically anisotropic layer provided on the support, and the support has an in-plane retardation (Re) of 0 to 20 nm and a retardation (Rth) in the thickness direction of −10 to 100 nm.

5. The liquid crystal display device according to claim 1,
wherein the first optical compensation film is a protective film of the polarizing film.

6. The liquid crystal display device according to claim 1,
wherein the first optical compensation film and a second optical compensation film are provided between the light source and the polarizing film, and the second optical compensation film has an in-plane retardation (Re) of 50 to 200 nm.

7. The liquid crystal display device according to claim 6,
wherein a cholesteric liquid crystal layer is further provided between the light source and the polarizing film so as to be closer to the light source than both the first optical compensation film and the second optical compensation film.

8. The liquid crystal display device according to claim 3,
wherein the first optical compensation film includes at least a support and the optically anisotropic layer provided on the support, and the support has an in-plane retardation (Re) of 0 to 20 nm and a retardation (Rth) in the thickness direction of −10 to 100 nm.

9. The liquid crystal display device according to claim 2,
wherein the first optical compensation film is a protective film of the polarizing film.

10. The liquid crystal display device according to claim 3,
wherein the first optical compensation film is a protective film of the polarizing film.

11. The liquid crystal display device according to claim 4,
wherein the first optical compensation film is a protective film of the polarizing film.

12. The liquid crystal display device according to claim 2,
wherein the first optical compensation film and a second optical compensation film are provided between the light source and the polarizing film, and the second optical compensation film has an in-plane retardation (Re) of 50 to 200 nm.

13. The liquid crystal display device according to claim 3,
wherein the first optical compensation film and a second optical compensation film are provided between the light source and the polarizing film, and the second optical compensation film has an in-plane retardation (Re) of 50 to 200 nm.

14. The liquid crystal display device according to claim 4,
wherein the first optical compensation film and a second optical compensation film are provided between the light source and the polarizing film, and the second optical compensation film has an in-plane retardation (Re) of 50 to 200 nm.

15. The liquid crystal display device according to claim 5,
wherein the first optical compensation film and a second optical compensation film are provided between the light source and the polarizing film, and the second optical compensation film has an in-plane retardation (Re) of 50 to 200 nm.
